(19) United States
(12) Patent Application Publication
(10) Pub. No.: US 2014/0158233 A1
(43) Pub. Date: Jun. 12, 2014

(54) AEROSOL DELIVERY TO A MICROFLUIDIC DEVICE

(71) Applicants: Daniel Christopher Leslie, Brookline, MA (US); Karel Domansky, Charlestown, MA (US); Geraldine A. Hamilton, Cambridge, MA (US); Anthony Bahinski, Wilmington, DE (US); Donald E. Ingber, Boston, MA (US)

(72) Inventors: Daniel Christopher Leslie, Brookline, MA (US); Karel Domansky, Charlestown, MA (US); Geraldine A. Hamilton, Cambridge, MA (US); Anthony Bahinski, Wilmington, DE (US); Donald E. Ingber, Boston, MA (US)

(73) Assignee: PRESIDENT AND FELLOWS OF HARVARD COLLEGE, Cambridge, MA (US)

(21) Appl. No.: 14/116,477

(22) PCT Filed: May 9, 2012
(86) PCT No.: PCT/US12/37096

§ 371 Date: Feb. 27, 2014

Related U.S. Application Data
(60) Provisional application No. 61/483,837, filed on May 9, 2011.
(60) Provisional application No. 61/541,876, filed on Sep. 30, 2011.

(51) Int. Cl. B05B 15/00

(52) U.S. Cl. CPC B05B 15/00
USPC 137/561 R

(57) ABSTRACT

The present invention is directed to systems and methods for delivering aerosolized micro-droplets into microfluidic devices. In some embodiments, the microfluidic devices are designed for the culture of living cells at an air interface. In some embodiments, the systems and methods described herein can be used to deliver aerosolized micro-droplet into detection systems and small animals, tissues, organs and organisms.

### CROSS-REFERENCE TO RELATED APPLICATIONS

This application claims benefit under 35 U.S.C. §119(e) of the U.S. Provisional Application No. 61/483,837 filed May 9, 2011, and U.S. Provisional Application No. 61/541,876 filed Sep. 30, 2011, the content of both of which is incorporated herein by reference in its entirety.

### GOVERNMENT SUPPORT

This invention was made with government support under grant no. 1U01NS073474-01 awarded by National Institute of Health. The government has certain rights in the invention.

### TECHNICAL FIELD

Provided herein is generally directed to delivery of aerosols to a chamber. In particular, provided herein relates to delivery of aerosols to microfluidic channels, e.g., in microfluidic devices and systems. In some embodiments, in vitro modeling systems for aerosol delivery of drugs, therapeutic agents and toxins are provided herein. In specific embodiments, a device is provided herein for delivering drugs, therapeutic agents and toxins in aerosol form to microfluidic channels and/or cell cultures, e.g., for use in drug efficacy, toxicology, testing of formulation effects (drug delivery) ADME (Absorption, Distribution, Metabolism, and Excretion) and toxicity studies.

### BACKGROUND

Currently, aerosol delivery of drugs, therapeutic agents and toxins to cells is conducted using costly and time-consuming animal studies. Although advances have been made in cell culture models, these methods, in many cases, still fail to accurately predict responses in humans mainly due to insufficient reconstitution of the key structural and mechanical features of the whole organ. Others have recognized that there are morphological and phenotypic differences of cells cultured at an air interface as opposed to in liquid media. See, e.g., Grainger et al. “Culture of Calu-3 Cells at the Air Interface Provides a Representative Model of the Airway Epithelial Barrier,” Pharmaceutical Research (2006) 23: 1482-1490. Accordingly, there is a need to develop methods and/or in vitro devices that can accurately predict, e.g., drug efficacy, bioavailability and toxicity, in humans in order to speed development and regulatory approval of new and safer medical products.

### SUMMARY

Delivering an agent (e.g., a drug) to cells at an air interface constitutes a challenge, especially on the micro-scale. Provided herein is directed to devices or systems and methods for delivering aerosolized micro-droplets into microfluidic devices. In some embodiments, the microfluidic devices can be designed for the culture of living cells at an air interface, e.g., for assessing an effect of an aerosolized agent on at least one cell cultured at an air interface in a microfluidic device. In some embodiments, the devices or systems and methods described herein can be used to deliver aerosolized micro-droplets into detection systems and small animals, tissues, organs and organisms.

In one aspect, provided herein relates to an aerosol delivery device for delivering an aerosol to a microfluidic module. The aerosol delivery device comprises (a) an aerosol producing element; and (b) a feed tube having an inner channel adapted to connect the aerosol producing element to the microfluidic module, wherein the aerosol can flow from the aerosol producing element into at least one microchannel of the microfluidic module.

An aerosol producing element can be any element or device that can atomize or turn a solution into an aerosol or a fine spray. In some embodiments, the aerosol producing element can include a nebulizer. Depending on types of nebulizers, the aerosol producing element can also include an air compressor to facilitate formation of an aerosol or a fine spray from a solution.

In order to control a flow rate of the aerosol into the feed tube and thus into a microchannel, in some embodiments, a flow splitting device defining one or more flow paths can be connected to the aerosol producing element and adapted to guide the aerosol along the one or more flow paths. The flow splitting device can direct a first portion of an aerosol generated from the aerosol producing element away from a flow path toward the feed tube, while a second portion of the aerosol can be simultaneously directed toward the feed tube and thus the microchannel. In some embodiments, the flow splitting device can be adapted to be capable of adjusting a flow rate of the aerosol flowing into the feed tube. For example, the flow splitting device can be connected to a valve (e.g., an adjustable valve) to control the flow rate of the aerosol flowing into the feed tube. In some embodiments, the first portion of the aerosol that did not enter the feed tube can be directed into a waste container. In some embodiments, the first portion of the aerosol that did not enter the feed tube in the previous pass can be re-circulated into the aerosol delivery device (e.g., into the flow splitting device and/or the aerosol producing element).

Feed tubes used in the aerosol delivery devices described herein can be made of any material that is inert to an aerosol. In some embodiments, it can be desirable to use a feed tube material that minimizes the chance of the aerosol depositing thereon. For example, in some embodiments, the feed tube can include a glass tube or fused silica tube.

Depending on types of the feed tube material (e.g., hydrophobic or hydrophilic) and/or properties of an agent (e.g., aqueous-based vs. organic-solvent based) to be aerosolized, in some embodiments, aerosolized microdroplets can coalesce on the inner surface of the feed tube and thus eventually occlude an aerosol flow through the feed tube. In such embodiments, the inner channel (e.g., the inner channel surface) of the feed tube can be treated to reduce the contact angle of the aerosol in the feed tube. Methods to reduce a contact angle of a material on a surface are known to one skilled in the art. For example, the inner channel of the feed tube can be plasma-treated or plasma-cleaned, e.g., with oxygen plasma. In some embodiments, the feed tube can be treated to oxidize the inner channel. In some embodiments, the feed tube can be treated to covalently bond polar moieties to the inner channel. In some embodiments, the feed tube can be treated to deposit a thin layer of a polar compound on the inner channel.

While the feed tube treated for reduced contact angle can allow an aerosol to flow more freely, in some embodiments, there can be an accumulation of an aerosol liquid in the feed tube, which can eventually flow out of the end of feed tube. In such embodiments, the aerosol delivery device can further comprise a well or a container at the end of the feed tube to collect the aerosol fluid draining from the feed tube as it enters the microfluidic module.

The feed tube can have an inner dimension (e.g., an inner diameter) of any size. The size of the feed tube can be adjusted to control flow rate and/or shear stress of the aerosol flowing in the microchannel. In some embodiments, the inner channel of the feed tube can have a cross-sectional dimension (e.g., diameter) of about 10 μm to about 10,000 μm (i.e., about 1 cm), about 20 μm to about 5000 μm, about 25 μm to about 1000 μm, about 50 μm to about 500 μm, or about 100 μm to about 300 μm. In one embodiment, the inner channel of the feed tube can have a cross-sectional dimension (e.g., diameter) of about 100 μm to about 300 μm.

The feed tube can be connected to anywhere in a microfluidic module. In some embodiments, the outlet of the feed tube directing an aerosol into a microchannel of the microfluidic module can be connected to a microchannel inlet adapted to deliver the aerosol from the side of the microfluidic module. In some embodiments, the outlet of the feed tube directing an aerosol into a microchannel of the microfluidic module can be connected to a microchannel inlet adapted to deliver the aerosol from the top and/or bottom of the microfluidic module.

In some embodiments, the droplets produced from an aerosol producing element can have a broad distribution of sizes. In order to reduce the chance of large droplets clogging a microchannel, in some embodiments, the aerosol delivery device can further comprise a droplet size separator (e.g., an inertial impactor) adapted for use in a microfluidic device. The droplet size separator (e.g., an inertial impactor) can be designed to filter out larger droplets of an aerosol before deposition on a microchannel. Without wishing to be bound by theory, larger droplets of the aerosol tend to have greater inertia than their smaller counterparts, resulting in a greater likelihood of hitting an obstacle in the flow path.

A size separator (e.g., an inertial impactor) can be placed anywhere between an aerosol producing element and a microfluidic channel. In some embodiments, a size separator (e.g., an inertial impactor) can comprise a chamber in fluid communication with at least one microchannel, wherein the chamber can include: (a) an aerosol inlet for entry of at least a portion of the aerosol produced from the aerosol producing element; (b) a capture surface opposing to the aerosol inlet, wherein the capture surface is placed at a pre-determined distance apart from the aerosol inlet such that one or more large droplets of the aerosol are collected on the capture surface, while one or more small droplets of the aerosol are capable of flowing into said at least one microchannel; and (c) an outlet adaptably connected to the at least one microchannel, wherein the outlet can be placed relative to the aerosol inlet such that a portion of the aerosol can flow from the aerosol inlet defining an axis to the outlet at an angle between about zero degrees and about 180 degrees relative to the axis, to the outlet and enter into the at least one microchannel. In some embodiments, the outlet can be placed relative to the aerosol inlet such that a portion of the aerosol can flow from the aerosol inlet defining a flow axis at an angle between about 30 degrees and about 150 degrees relative to the flow axis, to the outlet and enter into the at least one microchannel. In some embodiments, the outlet can be placed relative to the aerosol inlet such that a portion of the aerosol can flow from the aerosol inlet defining a flow axis at an angle between about 45 degrees and about 90 degrees relative to the flow axis, to the outlet and enter into the at least one microchannel.

In some embodiments, at least a portion of the capture surface can be placed directly opposite to the aerosol inlet. For example, the capture surface can be placed directly opposite to the aerosol inlet such that at least a portion of the aerosol traveling in a straight line along the axis defined by the aerosol inlet can hit or contact at least a portion of the capture surface. In some embodiments, said at least a portion of the capture surface can form an angle of greater than zero degree to less than 180 degrees, or greater than 45 degrees to less than 145 degrees, with the axis defined by the aerosol inlet. In one embodiment, said at least a portion of the capture surface can form a 90 degree angle with the axis defined by the aerosol inlet.

In some embodiments, a capture surface needs not be directly opposite to the aerosol inlet.

In some embodiments, the chamber can comprise more than one capture surfaces, e.g., 2 or more capture surfaces. In some embodiments, one of the capture surfaces need not be directly placed opposite to the aerosol inlet.

In some embodiments, the aerosol inlet can be adaptably connected to the aerosol producing element. In some embodiments, the aerosol inlet can be adaptably connected to the feed tube. In some embodiments, the aerosol inlet can be adaptably connected to the flow-splitting device.

In some embodiments, to further filter the smaller droplets, the at least one microchannel can comprise at least one or a plurality of micro-pillars disposed herein. Without wishing to be bound by theory, among the smaller droplets, the relatively larger ones having a linear flow path directed to a micro-pillar can preferentially deposit on the micro-pillar, while the smaller ones can more likely change the direction of their flow path to avoid the micro-pillar and continue to flow along the microchannel. The microchannel described herein can be part of a microfluidic channel of the microfluidic module, or can be connected to the microfluidic channel of the microfluidic module via an adaptor, e.g., a micro-tubing or a separate microchannel.

The aerosol delivery devices or systems and methods described herein can be used to deliver an aerosol to any microfluidic module that comprises at least one microchannel. In some embodiments, a microfluidic module can include an elongated microfluidic channel (or microchannel) extending from an inlet port to an outlet port and the feed tube is connected to the inlet port. In some embodiments, the microfluidic module can include a biomimetic organ on a chip device, e.g., a lung-on-a-chip device known in the art.

In any aspects described herein, the aerosol producing element can produce an aerosol containing at least one agent, e.g., drugs, therapeutic agents, toxins, cells, bacteria, viruses, particulates, nanoparticles, pollutants, contaminants, biologics, infectious agents, and any combination thereof. Accordingly, methods for delivering an aerosolized agent to a microfluidic module are also provided herein. In some embodiments, the method comprises (i) providing one or more embodiments of the aerosol delivery device described herein, (ii) generating an aerosol of an agent of interest with the aerosol producing element; and flowing the aerosolized agent from the aerosol producing element through the feed tube connecting to the microfluidic module, wherein at least a portion of the aerosolized agent flows from the feed tube into a microchannel of the microfluidic module and deposits on at least a portion of a surface of the microchannel. If the agent of interest is a coating solution, the method described herein can be used to coat at least a portion of the surface of the microchannel. Alternatively, if the microchannel comprises at least one cell on the surface of the microchannel, the aerosolized agent can deposit on said at least one cell cultured on the surface of the microchannel. In some embodiments, the cell can then uptake the agent. In some embodiments, if the agent of interest comprises cells, the method described herein can be used to deposit cells on at least a portion of the surface of the microchannel, or on said at least one cell on the surface of the microchannel.

In some embodiments, various aspects described herein can be applied, for example, to a breathing lung-on-a-chip device in order to model and measure pulmonary absorption, efficacy and toxicity of aerosol-based drugs, therapeutic agents, and toxins. Various embodiments described herein can also be applied to other organ on-a-chip devices to model and measure absorption, efficacy and toxicity of aerosol-based drugs, therapeutic agents, biologics, and toxins in airborne environments, or to deliver particular sized liquid droplets or vesicles. Accordingly, methods for determining an effect of an aerosolized agent on at least one cell in a microfluidic module are also provided herein. Such method comprises (i) providing one or more embodiments of the aerosol delivery device described herein, (ii) generating an aerosol of an agent with the aerosol producing element; (iii) flowing the aerosolized agent from the aerosol producing element through the feed tube connecting to the microfluidic module, wherein at least a portion of the aerosolized agent flows from the feed tube into a microchannel of the microfluidic module and deposits on at least one cell cultured in the microchannel; and (iv) detecting a response of said at least one cell after exposure to the aerosolized agent for a period of time, thereby determining the effect of the aerosolized agent on said at least one cell in the microfluidic module. The cell in the microfluidic module can be a normal cell or can be manipulated (e.g., chemically, genetically, mechanically, and/or radioactively) to induce a pathological change corresponding to a disease model of interest.

In accordance with one embodiment described herein, micrometer size liquid droplets can be delivered to a microchannel of a microfluidic device such as the previously reported lung-on-a-chip device. A nebulizer can be used to generate aerosolized liquid having droplets with a nominal median mass diameter by forcing air through an orifice. The liquid droplets in air can be sampled using a feed tube inserted into the flow path from the nebulizer. The droplets can flow through the feed tube into a microfluidic channel.

The suspended droplets passing through the microchannel can be imaged on a microscope and captured with a camera to characterize their size and velocity distribution. The distribution of velocities of individual droplets can be determined and the air velocity can be selected so as not to interfere with or damage the cells cultured at the air interface. The size and size distribution of the droplets flowing through the channel can also be determined. As the droplets suspended in air travel through the microchannel, some of them can be deposited on the channel walls. Bright field images of the channel before and after deposition of water droplets can be used to evaluate the distribution of the aerosol droplets along the channel. Using this method, drugs, biologics, and toxins can be administered to cells cultured at air interface in microfluidic channels, where the environment closely mimics the in vivo mechanical and structural environment. Ultimately, aerosol drug delivery to microfluidic cell culture devices can be used to provide a more accurate model for drug and toxicity screening.

These and other capabilities of various embodiments and aspects described herein will be more fully understood after a review of the following figures, detailed description, and claims.

### BRIEF DESCRIPTION OF THE FIGURES

FIG. 1 shows a block diagram of a microfluidic device and/or system modified to include an aerosol delivery device according to one embodiment described herein.

FIG. 2 shows a photograph of a microfluidic device and/or system modified to include an aerosol delivery device according to one embodiment described herein.

FIG. 3A shows a diagrammatic view of a flow splitting device according to one embodiment described herein shown in FIG. 1.

FIG. 3B shows a diagrammatic view of a flow splitting device according to another embodiment described herein shown in FIG. 1.

FIG. 4 shows a bright field image of the microchannel showing suspended droplets passing through a microchannel according to one embodiment described herein.

FIG. 5 shows a bright field image of FIG. 4, with background subtracted, of the microchannel showing suspended droplets passing through a microchannel according to one embodiment described herein.

FIG. 6 shows a histogram of the velocity profile of the droplets passing through a microchannel according to one embodiment described herein.

FIG. 7A is a set of sequential images of droplet deposition in a 400 μm-wide microchannel, showing the deposition process over the length of over half the microchannel. Numerical values indicate a time sequence. For example, a numeric value 1 refers to a time point before deposition. A larger numeric value indicates a later time point along the deposition process. Thus, the image with a numeric value of 4 shows that there are more droplets deposited in the microchannel.

FIG. 7B shows the deposition process over the length of over half the microchannel of FIG. 7A at a higher magnification.

FIG. 7C shows bright field images of the microchannel before the deposition of water droplets along the microchannel of FIGS. 7A (1) and 7B (1) at a higher magnification.

FIG. 7D shows bright field images of the microchannel after the deposition of water droplets along the channel of FIGS. 7A (4) and 7B (4) at a higher magnification.

FIG. 8 shows an exemplary lung-on-a-chip device that can be incorporated with one embodiment described herein for aerosol drug delivery in a microfluidic device.

FIG. 9A shows an image of droplet coalescence on the walls of glass micro-diameter tubing (feed tube), resulting in partial clogging of air flow.

FIG. 9B shows an image of large droplet being forced out of the micro-diameter tubing (feed tube) towards the lung epithelial cells, which can in turn create lethal shear force at the air-liquid interface.

FIG. 9C shows an image of free flowing aerosol after the surface of the glass micro-diameter tubing (feed tube) is treated with oxygen plasma. Excess liquid can flow out of the end of the tubing, forming a droplet on the outside of the tubing.

FIG. 10A is a schematic diagram showing inertial impaction, wherein droplets in air flow are discriminated by size. Without wishing to be bound by theory, larger droplets tend to have greater inertia, and thus preferentially hit and deposit on the obstacle (e.g., a chamber wall); while smaller droplets more likely continue with the flow of air.

FIG. 10B is a schematic diagram of an exemplary miniature inertial impactor, in which smaller droplet tend to flow into and deposit in the microchannel, while larger droplets that clog the channel are generally retained in the impactor. The inset shows a top view of a partial microchannel with a plurality of micro-pillars disposed therein, e.g., for further droplet size separation. For example, larger droplets flowing toward a micro-pillar in a microchannel can tend to hit and stick to the micro-pillar while smaller droplets flowing in a microchannel can continue with the flow of air.

FIG. 10C is a schematic diagram of another exemplary miniature inertial impactor, wherein the feed tube delivers an aerosol from the top of the microfluidic device. Larger droplets are generally forced to the bottom of the impactor, while smaller droplets can continue to flow into the microchannel. This configuration does not cause any blockage of a microchannel entrance.

FIG. 10D is a schematic diagram of an exemplary miniature inertial impactor, in which smaller droplet tend to flow into and deposit in more than one microchannels, while larger droplets that clog the channel are generally retained in the impactor.

FIG. 10E show images of the microchannel layer (top) and feed tube layer (bottom) of an exemplary miniature inertial impactor, in which smaller droplet tend to flow into and deposit in the microchannel (top), while larger droplets that clog the channel are generally retained in the impactor (bottom).

FIGS. 11A-11B is a set of images showing droplets of about 1-5 micrometers being deposited along the length and width of an exemplary PDMS surface microchannel. FIG. 11A shows an image before deposition. FIG. 11B shows an image of droplet deposition after 10 mins of flowing an aerosol of about 2.5 mM erioglaucine (Blue 1) in isotonic saline through the microchannel. In FIGS. 11A-11B, the feed tube delivers an aerosol from the side of the microfluidic device.

FIGS. 11C-11D is a set of images showing droplets of about 1-5 micrometers being deposited along the length and width of an exemplary PDMS surface microchannel. FIG. 11C shows an image before deposition. FIG. 11D shows an image of droplet deposition after 10 mins of flowing an aerosol of about 2.5 mM erioglaucine (Blue 1) in isotonic saline through the microchannel. In FIGS. 11C-11D, the feed tube delivers an aerosol from the top of the microfluidic device.

FIG. 11E is a set of differential interference contrast (DIC) Brightfield images showing aerosol deposition on a porous membrane. The top image was captured with a 20×LD objective, while the bottom image was captured at a 100× magnification (with a 63×LD objective and 1.5× Optovar).

FIGS. 12A-12B shows that deposition of aerosol is more significant on the bottom surface of the microchannel than on the top surface of the microchannel. FIG. 12A is a brightfield image showing aerosol deposition on the bottom surface of the microchannel. FIG. 12B is a brightfield image showing aerosol deposition on the top surface of the same portion of the microchannel in FIG. 12A.

FIG. 13 is a set of images showing various perspective views of an exemplary lung-on-a-chip modified for aerosol delivery. An example of a lung-on-a-chip can be found in Huh D. et al. (2010) Science 328: 1662-1668.

FIGS. 14A-14D is a set of time-course images showing the cell uptake of aerosolized fluorescein dye after deposition on the cells over a period of time: Time=0 min (FIG. 14A); Time=1 min (FIG. 14B); Time=2 mins (FIG. 14C); Time=10 mins after fluorescein deposition (FIG. 14D), wherein even fluorescein coating is shown across the channel.

### DETAILED DESCRIPTION OF EXEMPLARY EMBODIMENTS

Embodiments described herein are directed to much needed in vitro modeling systems that can more accurately predict drug, biologics, and toxin efficacy, ADME (absorption, distribution, metabolism, and excretion) and toxicity in humans. While various devices exist to model and mimic human organs, there are no devices for delivering aerosol based substances (e.g., but not limited to, drugs, therapeutics, biologics, particulates and toxins) to these models and microfluidic systems. Embodiments of various aspects described herein are directed to methods and devices for delivering aerosol based substances to microfluidic devices and micron sized environments. Systems and methods according to various embodiments described herein can help to speed the development and regulatory approval of new and safer medical products. Unlike the prior art, the systems and methods according to some embodiments described herein can take advantage of new biomimetic devices (e.g., organ-on-a-chip) that sufficiently reconstitute the key structural and mechanical features of the whole organ. For example, in one embodiment, the aerosol delivery device can include a biomimetic microfluidic device that reproduces the alveolar-capillary interface under physiologically relevant cyclic mechanical strain. See for example, published PCT Patent application no. WO 2010/009307, which is hereby incorporated by reference.

In one aspect, provided herein relates to an aerosol delivery device for delivering an aerosol to a microfluidic module. The aerosol delivery device comprises (a) an aerosol producing element; and (b) a feed tube having an inner channel adapted to connect the aerosol producing element to the microfluidic module, wherein the aerosol can flow from the aerosol producing element into at least one microchannel of the microfluidic module.

In accordance with one embodiment described herein, an aerosol delivery system delivers micrometer sized liquid droplets to a microchannel of a microfluidic module. A commercial prescription nebulizer (such as a PARI nebulizer) can be used to generate aerosolized liquid having droplets with a nominal median mass diameter of, for example, approximately 3.8 μm by forcing air through an orifice. The liquid droplets in air can be sampled or split off using a feed tube inserted into the flow path from the nebulizer. The droplets can flow through the feed tube into an 80-μm-deep, 400-μm-wide microfluidic channel.

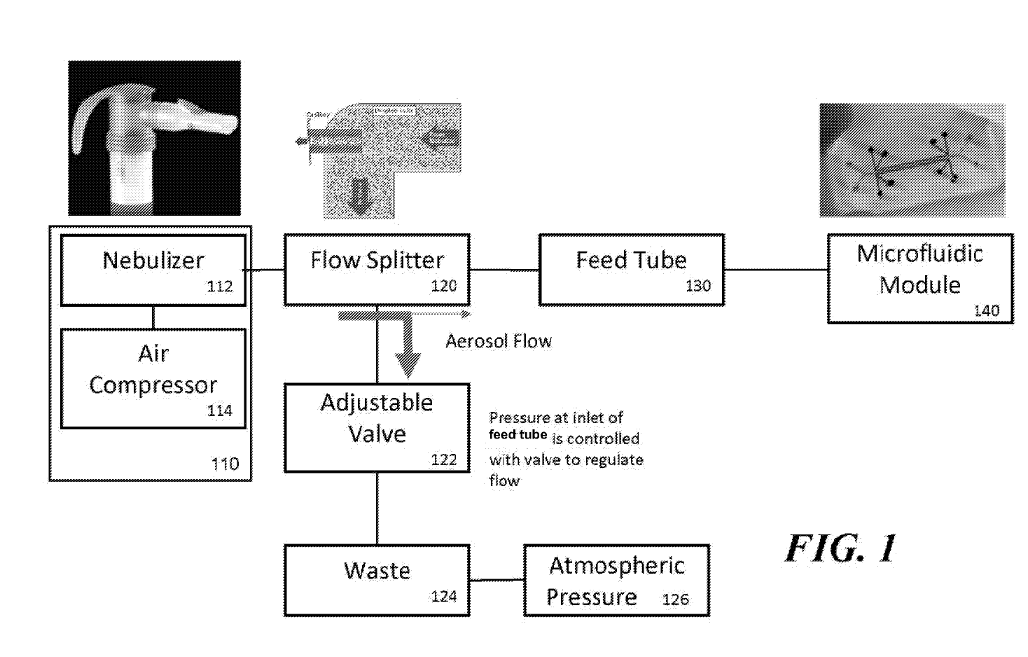

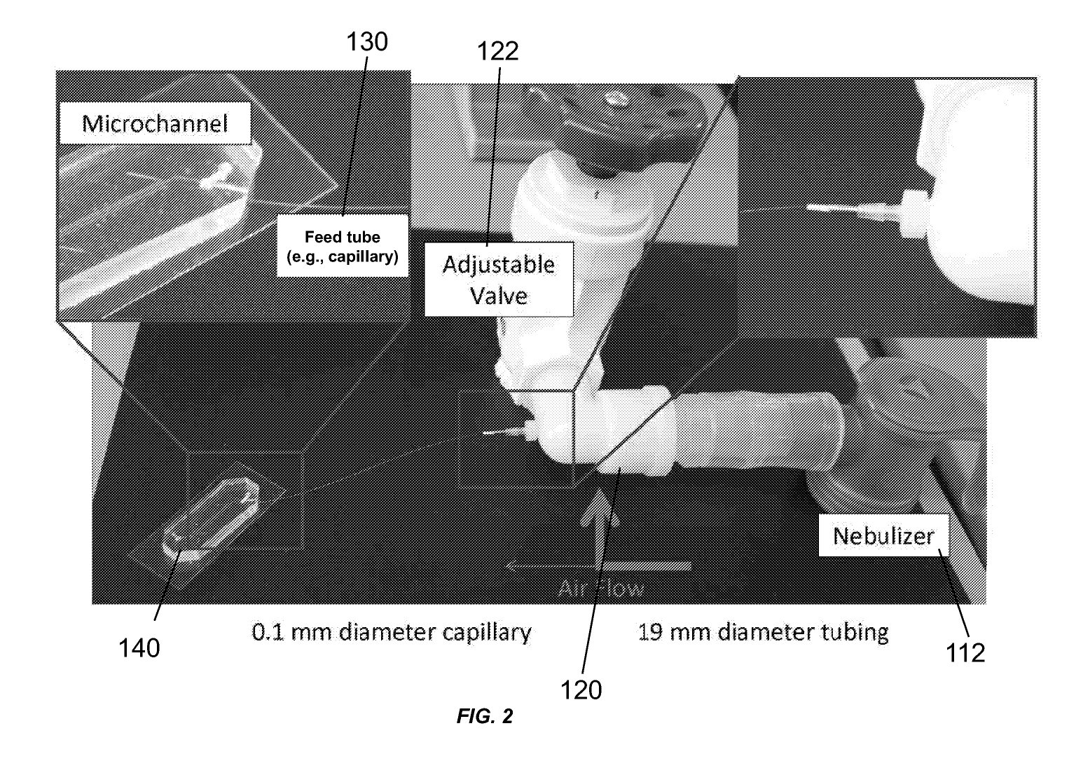

By way of example only, FIG. 1 shows a diagram of an aerosol delivery system 100 according to one or more embodiments described herein. The system includes an aerosol producing element 110, a flow splitting device 120, a feed tube 130 and a microfluidic module 140. In accordance with one embodiment described herein, the aerosol producing element 110 can include a nebulizer 110 and an air compressor 112. In accordance with one embodiment described herein, the flow splitting device 120 can include an adjustable valve 122 and a waste aerosol receiver 124 coupled to atmospheric pressure 126. The flow splitting device 120 can also include a port for receiving a feed tube 130. The feed tube 130 connects the aerosol producing element 110 to the microfluidic module 140 and allows aerosol particles to flow from their source at the aerosol producing element 110 to the microfluidic channel or microchannel of the microfluidic module 140. While FIGS. 1 and 2 illustrate the use of a flow splitting device in accordance with one embodiment of an aerosol delivery device and/or system described herein, the flow splitting device is not required in some embodiments, e.g., when the aerosol producing element can generate a flow rate of an aerosol low enough to be delivered to a feed tube in the absence of a flow splitting device.

Aerosol Producing Element 110:

The aerosol producing element 110 can include any element or device that can produce aerosol liquid droplets of substances or agents to be evaluated, such as drugs, therapeutic agents, toxins, and particles, and/or atomize or turn a solution comprising at least one agent into an aerosol or a fine spray. The size and quantity of droplets can be selected by the design of the nebulizer or atomizer. In one embodiment, the aerosol producing element 110 produces aerosolized liquid droplets with a nominal median mass diameter of about 3.8 μm at a pressure of 18 psi. In other embodiments, the aerosolized liquid droplets can have a nominal median mass diameter ranging from about 0.01 μm to about 50 μm, about 0.05 μm to about 25 μm, about 0.1 μm to about 15 μm, about 1 μm to about 10 μm, or about 1 μm to about 7 μm, and the air pressure can range from about 0.1 psi to about 100 psi, about 0.5 psi to about 75 psi, about 1 psi to about 50 psi, about 5 psi to about 25 psi, or about 10 psi to about 20 psi.

In accordance with one embodiment described herein, the aerosol producing element 110 can include a nebulizer (e.g., PARI Respiratory Equipment, Inc., Richmond, Va.). The nebulizer system can include a nebulizer cup 112 for containing one or more agents to be nebulized. Additionally, the nebulizer can include a mechanical unit to convert a liquid comprising one or more agents into an aerosol or a mist. Depending on different types of nebulizers, the aerosol producing element can also include an air compressor to facilitate formation of an aerosol or a fine spray from a solution. For example, a jet nebulizer can include a compressor 114, which causes compressed air or oxygen to flow at high velocity through a liquid comprising one or more agents and thus turn the liquid into an aerosol or a mist. In such embodiments, the compressor 114 can be connected to the nebulizer 112, e.g., by a tube providing compressed air to the nebulizer 112. In other embodiments, the other nebulizing devices, vaporizing devices, dry powder insufflators, pressurized metered dose inhalers, ultrasonic aerosol generators, or atomizing devices can be used. In other embodiments, the aerosol producing element can produce smoke. In other embodiments, the aerosol producing element can produce air borne or gas borne particles and particulates or combinations particles and liquid droplets.

In some embodiments, the nebulizer can include at least one port for addition of desired agent and/or removal of liquids from the nebulizer cup. For example, the nebulizer can include a replenishing port, which allows additional liquid comprising one or more agents to be added to the nebulizer cup while the nebulizer is engaged to the rest of the aerosol delivery device or system. The replenishing port can further include a flexible piece (e.g., rubber) on an outer end of the port such that it can be punctured, e.g., with a syringe or similar articles, to deliver a liquid comprising one or more agents through the port. After delivery of the liquid through the port, the punctured flexible piece can be resealable, e.g., to prevent contamination of the liquid. In some embodiments, the nebulizer can also include a suction port for removing residual liquid from the nebulizer cup 112 after a particular dose of liquid comprising one or more agents (e.g., drug formulation) has been dispensed from the nebulizer cup.

Flow Splitting Device 120:

In some embodiments, the aerosol delivery device can further comprise a flow splitting device. Accordingly, in some embodiments, the aerosol delivery device can comprise (a) an aerosol producing element; (b) a flow splitting device defining a flow path connected to the aerosol producing element and adapted to guide the aerosol along the flow path, and (c) a feed tube having an inner channel connecting the flow splitting device to the microfluidic module, wherein the aerosol can flow from the aerosol producing element into at least one microchannel of the microfluidic module.

FIG. 2 shows a diagram of a flow splitting device 120 according to one embodiment described herein. The flow splitting device 120 can include a relatively large diameter tube connected to the aerosol producing element 110 that can receive all or most of the aerosol produced. The flow rate of the aerosol generated from the aerosol producing element can sometimes be too high for use in a microfluidic module. Accordingly, in order to control a flow rate of the aerosol into the feed tube and thus into a microchannel, the flow splitting device 120 can direct a first portion of an aerosol generated from the aerosol producing element to deviate from a first flow path 121 toward the feed tube, while simultaneously allowing a second portion of the aerosol to flow along the first flow path 121 toward the feed tube. In some embodiments, the flow splitting device can provide a second flow path 123 for the aerosol to flow from the source to the waste receiver/receptacle 124. For example, the flow splitting device 120 can direct the first portion of the aerosol generated from the aerosol producing element to flow into the waste receiver/receptacle 124. In alternate embodiments, the flow splitting device 120 can direct the first portion of the aerosol generated from the aerosol producing element into the aerosol delivery device for re-circulation.

In some embodiments, the flow splitting device 120 can be adapted to be capable of adjusting a flow rate of the aerosol flowing into the feed tube. For example, the flow splitting device 120 can comprise a valve 122, e.g., an adjustable valve, to control the pressure and/or flow rate of the aerosol flowing into the feed tube and thus the microchannel. By way of example only, an adjustable valve 122 can be provided at the bend, or downstream of the bend, of the second flow path 123 between the aerosol producing element 110 and waste receiver/receptacle 124 or re-circulation route. The term “valve,” as used herein, includes any passive or actuated fluid flow controller or other actuated mechanism for selectively passing a fluid through an opening, including, without limitation, ball valves, plug valves, butterfly valves, choke valves, check valves, gate valves, leaf valves, piston valves, poppet valves, rotary valves, slide valves, solenoid valves, 2-way valves, or 3-way valves. Valves can be actuated by any method, including, without limitation, by mechanical, electrical, magnetic, camshaft-driven, hydraulic, or pneumatic means.

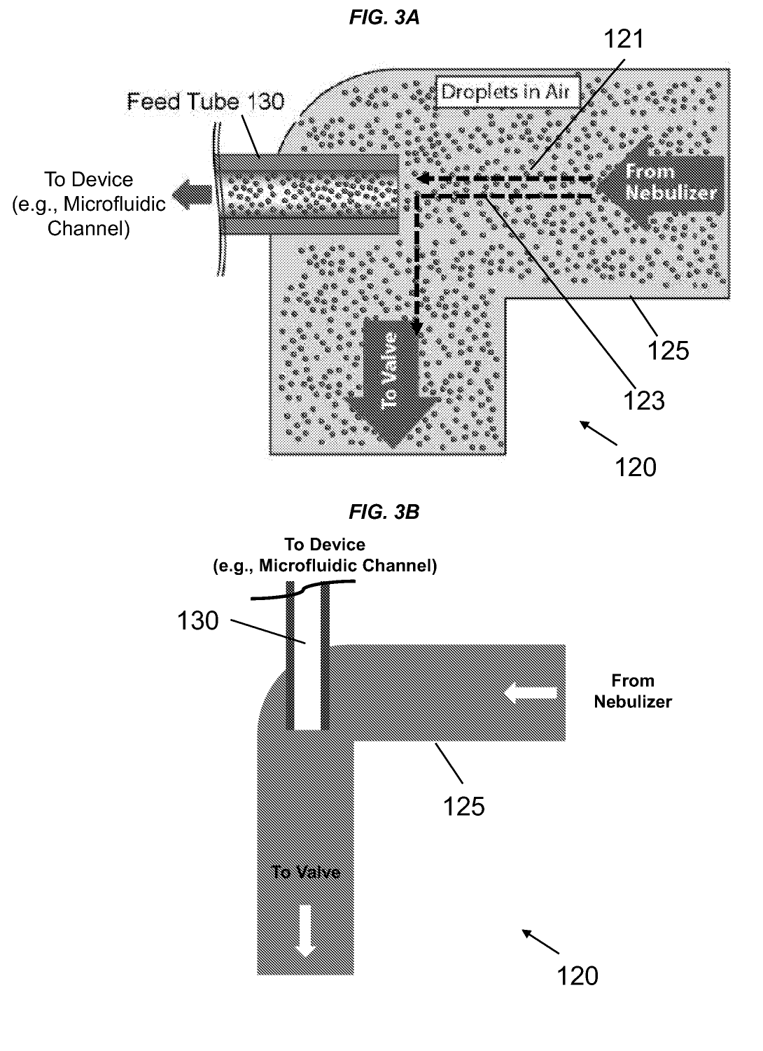

In accordance with one embodiment, the flow splitter 120 can include a tube having a 90 degree bend and a feed tube 130 extending substantially parallel to at least a portion of the flow path into the flow of the aerosol. Stated another way, the feed tube 130 can extend substantially parallel to a portion of the flow path before the 90-degree bend into the flow of the aerosol (e.g., as shown in FIG. 3A). Alternatively, the feed tube 130 can extend substantially parallel to a portion of the flow path after the 90-degree bend into the flow of the aerosol (e.g., as shown in FIG. 3B). Accordingly, in some embodiments, as shown in FIG. 3A, the aerosol can flow along the flow path toward the 90 degree bend and the feed tube can extend substantially parallel to the flow path through the transverse wall of the 90 degree bend. The pressure and inertia of the aerosol droplets can cause a portion of the aerosol to enter the feed tube 130 and flow toward the microfluidic module 140. In alternative embodiments, as shown in FIG. 3B, the aerosol can flow along the flow path toward the 90 degree bend and the feed tube can extend substantially perpendicular to the flow path through the wall upstream of the 90 degree bend. The pressure of the aerosol droplets can cause a portion of the aerosol to enter the feed tube 130 and flow toward the microfluidic module 140.

In other embodiments, the flow path along the tube 125 can include a bend ranging from 0 degrees to 179 degrees and the feed tube 130 can be mounted and configured to extend substantially parallel to the flow of the aerosol on the incoming flow path. In other embodiments, the feed tube 130 can be oriented between 0 degrees and 90 degrees to the flow path or direction of flow of the aerosol.

While FIGS. 3A-3B illustrate one feed tube connected to the flow splitting device 120, it should be appreciated that, in some embodiments, at least 2 feed tubes 130, including at least 3, 4, 5, 6, 7, 8, 9, 10, or more feed tubes, can extend, or can be mounted and configured to extend, substantially parallel to at least a portion of the flow path into the flow of the aerosol. In such embodiments, each feed tube 130 can lead to a different microchannel of the microfluidic module, or more than one feed tubes 130 can lead to the same microchannel.

Feed Tubes 130:

The feed tube 130 can include a relatively small diameter tube that is large enough for the aerosol to flow from the flow splitting device 120 to the microfluidic module 140. In accordance with one embodiment described herein, the feed tube 130 can include a 100 μm inside diameter capillary tube (e.g., glass capillary tube) to accommodate the 3.8 μm aerosolized liquid droplets. The appropriate inside diameter of the feed tube 130 as well as any treatment or coating to the inside of the capillary tube 130 can be selected according to the characteristics of the material or agent to be transferred or delivered in the aerosol and/or the desired flow rate of the aerosol. Thus, for larger molecular materials or agents or fluids forming larger droplets or to accommodate a larger flow rate of the aerosol, a larger diameter feed tube 130 (e.g., capillary tube) can be used; and, similarly, for smaller materials or agents or fluids forming smaller droplets or to accommodate a smaller flow rate of the aerosol, a smaller diameter feed tube 130 (e.g., capillary tube) can be used. Accordingly, the feed tube 130 can have an inner dimension (e.g., an inner diameter) of any size. The size of the feed tube can be adjusted to control flow rate, shear stress of the aerosol flowing in the microchannel, and/or droplet sizes. In some embodiments, the inner channel of the feed tube can have a cross-sectional dimension (e.g., diameter) of about 10 μm to about 10,000 μm (i.e., about 1 cm), about 20 μm to about 5000 μm, about 25 μm to about 1000 μm, about 50 μm to about 500 μm, or about 100 μm to about 300 μm. In one embodiment, the inner channel of the feed tube can have a cross-sectional dimension (e.g., diameter) of about 100 μm to about 300 μm. While in the illustrated embodiments, the feed tube 130 has a circular inside diameter, in accordance with some embodiments described herein, the inside cross-section of the feed tube can be given any shape, for example, oval, square, rectangular, polygonal or any irregular shape.

In accordance with other embodiments provided herein, feed tubes used in the aerosol delivery devices described herein can be made of any material that is inert to an aerosol. In some embodiments, it can be desirable to use a feed tube material that minimizes the chance of the aerosol depositing thereon. For example, the feed tube 130 can be made of glass, metal, plastic or polymer materials or any combinations thereof. The preferred material is glass or plastic. In some embodiments, the feed tube can include a glass tube or fused silica tube.

Exemplary Surface Modification of a Feed Tube 130:

Depending on types of the feed tube material (e.g., hydrophobic or hydrophilic) and/or properties of an agent (e.g., aqueous-based vs. organic-solvent based) to be delivered, in some embodiments, aerosolized microdroplets (e.g., of aqueous-based aerosolized microdroplets) can coalesce on the inner surface of the feed tube (e.g., hydrophobic surface) and thus eventually occlude an aerosol flow through the feed tube. Thus, in some embodiments, the inner channel (e.g., the inner channel surface) of the feed tube can be treated to reduce the contact angle of the aerosol in the feed tube. Methods to reduce a contact angle of a material on a surface are known to one skilled in the art. For example, the inside surface of the feed tube 130 can be formed of or coated with a material or treated to lower the contact angle of the aerosol liquid when it comes in contact with the inside of the feed tube 130. By reducing the contact angle for the selected aerosol liquid, the likelihood of aerosol droplets to bead on the inside of the feed tube 130 and obstruct the flow of the aerosol through the feed tube 130 or result in the creation of large droplets (formed by the droplets coalescing) being expelled from the feed tube 130 can be lowered. In accordance with some embodiments described herein, the inner surface of the feed tube can be treated such that the contact angle of the aerosol liquid in the feed tube can be less than 60 degrees, less than 50 degrees, less than 40 degrees, less than 30 degrees, less than 20 degrees, or less than 10 degrees.

In accordance with one embodiment described herein, the feed tube 130 (e.g., formed from a fused silica capillary tube, e.g., with a 100 μm inside diameter) can have the inside surface plasma cleaned to reduce the contact angle of the aerosol liquid. In some embodiments, the material of the feed tube 130 can be selected to naturally have a lower contact angle with the intended aerosol liquid. In some embodiments, the inside surface of the feed tube 130 can be oxidized to reduce the contact angle with an aerosol liquid. In some embodiments, the feed tube 130 can be treated to covalently bond polar moieties (or hydrophilic moieties), e.g., but not limited to, aminopropyltrimethoxysilane or derivatives thereof, to the inside surface, in order to reduce the contact angle with an aerosol liquid, for example, an aqueous-based aerosol liquid. In some embodiments, the feed tube 130 can be treated to deposit a thin layer of a polar compound (or a hydrophilic compound), e.g., but not limited to, silica or derivatives thereof, to the inside surface, in order to reduce the contact angle with an aerosol liquid, for example, an aqueous-based aerosol liquid.

In some embodiments, for example, to reduce a contact angle of organic solvent-based aerosol on an inner surface of a feed tube, the feed tube 130 can be treated to covalently bond non-polar moieties (or hydrophobic moieties), e.g., but not limited to, octyltrichlorosilane, to the inside surface, in order to reduce the contact angle with an aerosol liquid. In some embodiments, the feed tube 130 can be treated to deposit a thin layer of an apolar compound (or a hydrophobic compound), e.g., but not limited to, polydimethylsiloxane, to the inside surface, in order to reduce the contact angle with an aerosol liquid.

Without wishing to be bound by theory, the contact angle can be sensitive to surface contamination (e.g., by organic molecules) or roughness. Thus, the inside surface of the feed tube 130 can be cleaned, e.g., but not limited to, by UV/ozone cleaning, plasma cleaning, ion bombarding, sputtering cleaning, vacuum baking, water washing, alkali cleaning, acid cleaning, detergent cleaning, solvent cleaning, jet cleaning, and any combination thereof. In some embodiments, the inside surface of the feed tube can be plasma cleaned, e.g., with oxygen, to reduce the contact angle of the aerosol in the feed tube.

While the feed tube treated for reduced contact angles can allow an aerosol to flow more freely, in some embodiments, there can be an accumulation of an aerosol liquid in the feed tube, which can eventually flow out of the end of feed tube. In such embodiments, the aerosol delivery device can further comprise a well or a container at the end of the feed tube to collect the aerosol fluid draining from the feed tube as it enters the microfluidic module.

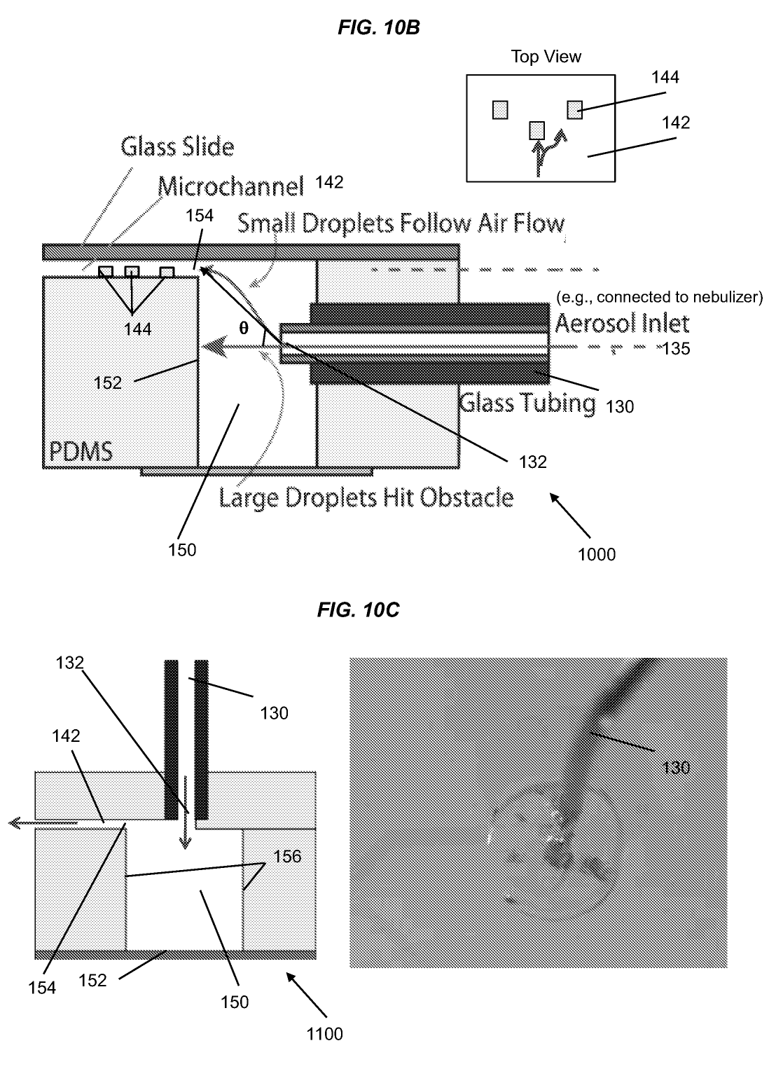

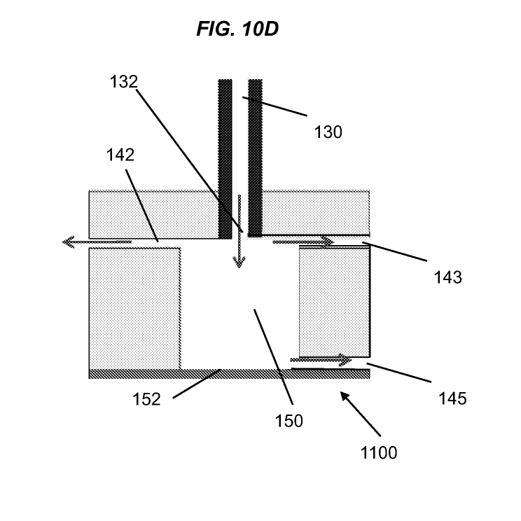

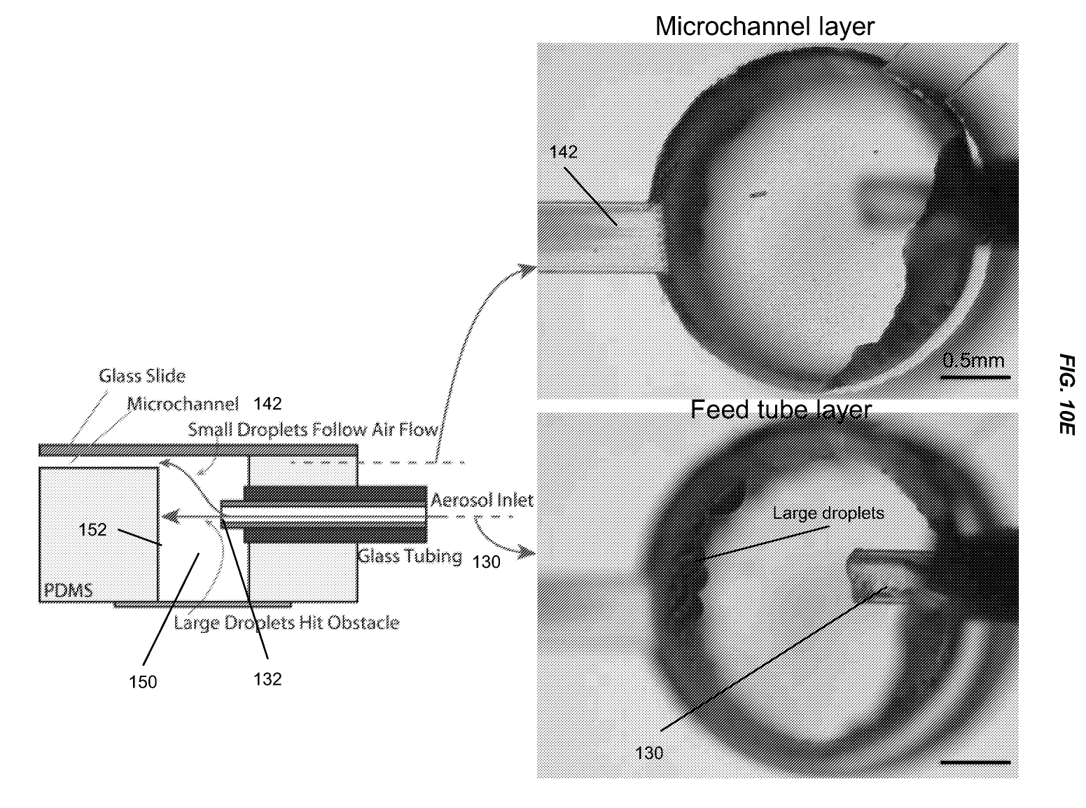

The feed tube can be connected to anywhere in a microfluidic module. In some embodiments, as shown in FIG. 10B, the outlet of the feed tube directing an aerosol into a microchannel of the microfluidic module can be connected to a microchannel inlet adapted to deliver the aerosol from the side of the microfluidic module. In some embodiments, as shown in FIG. 10C, the outlet of the feed tube directing an aerosol into a microchannel of the microfluidic module can be connected to a microchannel inlet adapted to deliver the aerosol from the top of the microfluidic module. In some embodiments, the outlet of the feed tube directing an aerosol into a microchannel of the microfluidic module can be connected to a microchannel inlet adapted to deliver the aerosol from the bottom of the microfluidic module.

In accordance with various embodiments of any aspects described herein, the feed tube 130 can be used to deliver an aerosol to a micron size environment, such as a microfluidic module, a sensor or detector (or array of sensors or detectors), a small animal, an explanted whole organ, cultured organ rudiment, or similar environment. In operation, the aerosol producing element 110 can produce an aerosol of a substance or an agent (e.g. one or more drug, therapeutic agents, biological agents, toxins, particles such as nanoparticles, or combination thereof) and, for example, using pressure, is directed into the feed tube 130. In some embodiments, the aerosol producing element 110 can produce an aerosol of a substance or an agent (e.g. one or more drug, therapeutic agents, biological agents, toxins, particles such as nanoparticles, or combination thereof) and, for example, using pressure, is directed into the flow splitter 120. In such embodiments, the aerosol can flow through a tube along a flow path in the flow splitter 120 toward the feed tube 130. In some embodiments, only a portion of the aerosol flows into the feed tube 130 and the remainder of the aerosol flows through an adjustable valve 122 to a waste receiver/receptacle 124, to be collected and reused or disposed of, or to a re-circulation route. In some embodiments, the fluid collected in the waste receiver 124 can be fed back into the aerosol producing element and reused. The valve 122 can be adjusted to control the flow of the aerosol into the feed tube 130. Depending on types and/or location of the valve with respect to a flow path, in some embodiments, closing, completely or partially, the valve (e.g., with respect to a flow path 123 toward a waste receiver/receptacle 124 or toward a re-circulation route) can increase the pressure at the feed tube 130 and increase the flow rate of the aerosol droplets through the feed tube 130; and opening, completely or partially, the valve (e.g., with respect to a flow path 123 toward a waste receiver/receptacle 124 or toward a re-circulation route) can decrease the pressure and decrease the flow rate of the aerosol droplets through the feed tube 130. In other embodiments, closing, completely or partially, the valve (e.g., with respect to a flow path 121 toward a feed tube) can decrease the pressure at the feed tube 130 and decrease the flow rate of the aerosol droplets through the feed tube 130; and opening, completely or partially, the valve (e.g., with respect to a flow path 121 toward a feed tube) can increase the pressure and increase the flow rate of the aerosol droplets through the feed tube 130. Thus, this can enable the system to control the rate at which the aerosol-based substance or agent is delivered. By taking into consideration the concentration of the substance or agent being delivered as well as the diameter of the feed tube, the delivery rate of an aerosol can be quantified.

Exemplary Aerosol Droplet Size Separation:

In some embodiments, the droplets produced from an aerosol producing element can have a broad distribution of sizes. In order to reduce the chance of large droplets clogging a microchannel or to separate larger droplets from smaller droplets (e.g., to mimic the upper airways of a lung filtering out larger droplets of an aerosol before deposition on an alveolar epithelium), in some embodiments, an airway mimic, a particle discriminator, a droplet size separator, or a cascading impactor can be incorporated in the aerosol delivery device or system described herein. In one embodiment, the airway mimic, the particle discriminator, a droplet size separator, or a cascading impactor can be positioned between the aerosol producing element 110 and the flow splitting device 120 to control the size of the particles or aerosol droplets that flow into the microfluidic module 140. In an alternative embodiment, the airway mimic, the particle discriminator, a droplet size separator, or a cascading impactor can be positioned between feed tube 130 and the microfluidic module 140 to control the size of the particles and/or aerosol droplets that flow into the microfluidic module. In some embodiments, the airway mimic, the particle discriminator, a droplet size separator, or a cascading impactor can be positioned between the aerosol producing element 110 and a microchannel of the microfluidic module 140 to control the size of the particles and/or aerosol droplets that flow into the microfluidic module.

In some embodiments, the airway mimic, the particle discriminator, a droplet size separator, or a cascading impactor can include an inertial impactor designed to filter out larger droplets of an aerosol before deposition on a microchannel. Without wishing to be bound by theory, larger droplets of the aerosol tend to have greater inertia than their smaller counterparts, resulting in a greater likelihood of hitting an obstacle in the flow path (FIG. 10A).

For example, in some embodiments, as shown in FIGS. 10B-10C, a droplet size separator or an inertial impactor 1000 or 1100 incorporated in one or more embodiments of the aerosol delivery device and/or system described herein can comprise a chamber 150 in fluid communication with at least one microchannel 142, wherein the chamber 150 can include: (a) an aerosol inlet 132 for entry of at least a portion of the aerosol produced from the aerosol producing element 110; (b) an outlet 154 adaptably connected to the at least one microchannel 142; and (c) at least one capture surface, including 1, 2, 3, or more capture surfaces, e.g., 152 (e.g., a solid surface or obstacle), opposing to the aerosol inlet 132, wherein the capture surface 152 can be placed at a pre-determined distance apart from the aerosol inlet 132 such that one or more large droplets of the aerosol can be collected on one or more capture surfaces 152, while one or more small droplets of the aerosol are capable of flowing into said at least one microchannel 142, including at least two, at least three, at least four, at least five or more microchannels. The size of droplets collected on the capture surface 152 and/or allowed to flow into a microchannel 142 can vary with the pre-determined distance between the capture surface 152 and the outlet 132 of the feed tube 130. In some embodiments, the pre-determined distance between the capture surface 152 and the outlet 132 of the feed tube can range from about 0.1 mm to about 10 mm, about 0.5 mm to about 5 mm, or about 1 mm to about 3 mm. Without wishing to be bound by theory, the shorter the pre-determined distance between the capture surface 152 and the aerosol inlet 132, the smaller the aerosol droplets flow into a microchannel. Accordingly, a skilled artisan can determine an optimal distance between the capture surface 152 and the aerosol inlet 132 for a desirable droplet size flowing to a microchannel, for example, by experiments, and/or by computational modeling, e.g., based on a number of parameters including, but not limited to, design and dimensions of the chamber, flow rate the aerosol, and properties of the aerosol droplets (e.g., density, volume, viscosity).

The outlet 154 of a chamber 150 of a droplet size separator (e.g., an inertial impactor) is adaptably connected to the at least one microchannel 142. In some embodiments, the outlet 154 can be placed relative to the aerosol inlet 132 such that the flow path of the aerosol from the aerosol inlet 132 to the outlet 154 comprises a turn or a bend (e.g., a change in direction). For example, the outlet 154 can be placed relative to the aerosol inlet 132 such that a portion of the aerosol can flow from the aerosol inlet 132 defining an axis (flow axis) 135, to the outlet 154, at an angle θ between greater than zero degree and about 180 degrees (or between greater than zero degree and less than 180 degrees) relative to the axis (flow axis) 135 and enter into the at least one microchannel 142. For example, as shown in FIG. 10B, the outlet 154 of the inertial impactor 1000 can be placed relative to the aerosol inlet 132 such that a portion of the aerosol can flow from the aerosol inlet 132 defining a flow axis 135, to the outlet 154, at an angle θ between greater than 10 degrees and about 90 degrees relative to the flow axis 135, and enter into the at least one microchannel 142. Depending on the placement of the aerosol inlet 132 relative to the outlet 154 connecting to microfluidic module 140, in some embodiments, as shown in FIG. 10C or 10D, the outlet 154 of the inertial impactor 1100 can be placed relative to the aerosol inlet 132 such that a portion of the aerosol can flow from the aerosol inlet 132 defining a flow axis 135, to the outlet 154, at an angle θ of about 90 degrees relative to the flow axis 135, and enter into the at least one microchannel 142. In some embodiments, the outlet 154 can be placed relative to the aerosol inlet 132 such that a portion of the aerosol can flow from the aerosol inlet 132 defining a flow axis 135, to the outlet 154, at an angle θ between about 30 degrees and about 150 degrees relative to the flow axis 135, and enter into the at least one microchannel 142. In some embodiments, the outlet 154 can be placed relative to the aerosol inlet 132 such that a portion of the aerosol can flow from the aerosol inlet 132 defining a flow axis 135, to the outlet 154, at an angle between greater than 90 degrees and less than 180 degrees relative to the flow axis 135, and enter into the at least one microchannel 142. In some embodiments, the outlet 154 can be placed relative to the aerosol inlet 132 such that a portion of the aerosol can flow from the aerosol inlet 132 defining a flow axis 135, to the outlet 154, at an angle between about 45 degrees and about 90 degrees relative to the flow axis 135, and enter into the at least one microchannel 142.

In some embodiments, at least a portion of the capture surface(s), e.g., 152, can be placed directly opposite to the aerosol inlet 132. For example, the capture surface 152 can be placed directly opposite to the aerosol inlet 132 such that at least a portion of the aerosol traveling in a straight line along the axis 135 defined by the aerosol inlet 132 can hit or contact at least a portion of the capture surface 152. In some embodiments, said at least a portion of the capture surface 152 can form an angle of greater than zero degree to less than 180 degrees, or greater than 45 degrees to less than 145 degrees, with the axis 135 defined by the aerosol inlet 132. In one embodiment, said at least a portion of the capture surface 152 can form a 90 degree angle with the axis 135 defined by the aerosol inlet 132, for example, as shown in FIGS. 10B-10D.

In some embodiments, a capture surface, e.g., 152, needs not be directly opposite to the aerosol inlet 132. By way of example only, as shown in FIG. 10C, the side wall(s) 156 of the chamber 150 can also act as a capture surface described herein. Without wishing to be bound by theory, in such embodiments, there may be fewer large aerosol droplets collected on the side wall 156, when compared to the number of aerosol droplets collected on the capture surface 152 directly opposite to the aerosol inlet 132. In some embodiments, at least a portion of the side wall(s) 156 can be tilted at an angle, e.g., to facilitate the capture of larger droplets in the aerosol.

In some embodiments, the chamber 150 can comprise more than one capture surfaces 152, e.g., 2 or more capture surfaces. In some embodiments, one of the capture surfaces 152 needs not be directly placed opposite to the aerosol inlet 132.

In some embodiments, the aerosol inlet 132 can be adaptably connected to the aerosol producing element 110. In some embodiments, the aerosol inlet 132 can be adaptably connected to the feed tube 130. In some embodiments, the aerosol inlet can be adaptably connected to the flow-splitting device 120.

In some embodiments, as the smaller droplets enter the microchannel 142, in order to further filter the small droplets, the microchannel 142 can comprise at least one or a plurality of micro-pillars 144 disposed herein. Without wishing to be bound by theory, among the smaller droplets, the relatively larger ones having a linear flow path directed to a micro-pillar 144 can preferentially deposit on the micro-pillar 144, while the smaller ones can more likely change the direction of their flow path to avoid the micro-pillar 144 and continue to flow along the microchannel 142. The microchannel 142 described herein can be part of a microfluidic channel of the microfluidic module 140, or can be connected to the microfluidic channel of the microfluidic module 140 via an adaptor, e.g., a micro-tubing or a separate microchannel.

While FIGS. 10B-10C illustrate an inertial impactor 1000, 1100 having one microchannel 142 into which a portion of aerosol droplets can flow, it should be appreciated that, in some embodiments, more than one microchannels 142, 143, 145 can be in fluid communication with a chamber 150 provided that the flow path of the aerosol from the aerosol inlet 132 to the respective microchannel 142, 143, 145 comprises a turn or a bend (e.g., a change in direction) as described earlier, as shown in FIG. 10D. The microchannels 142, 143, 145 can direct an aerosol to different microfluidic channels of the same or a different microfluidic module.

In some embodiments, an inertial impactor described herein can perform as both a particle discriminator and a flow-splitting device, where part of the aerosolized fluid in the chamber 150 (e.g., in FIG. 10B or 10C) can be diverted to somewhere else other than into a microchannel 142. For example, there can be another outlet disposed in the chamber 150 to divert part of the flow, e.g., in order to control the flow rate of the aerosol into a microchannel. In such embodiments, a separate flow-splitting device may not be needed.

In some embodiments, a droplet size separator or a particle impactor, including a cascading impactor, known in the art can be modified for use in one or more embodiments of an aerosol delivery device and/or system described herein. For example, the particle separators and/or impactors described, e.g., in U.S. App. No. US2010/0186524, can be modified and integrated into one or more embodiments of an aerosol delivery device and/or system described herein.

In some embodiments described herein, the system can be used to replace a particle impactor. Using imaging techniques, such as those shown in examples below, the system can measure particle and droplet size and distribution using high speed imaging (still and video), by flowing the aerosol to be evaluated into the microfluidic device at predefined flow rates and for predefined time periods, e.g., to simulate aerosol intake in the lungs.

### An Exemplary Aerosol Delivery System

The aerosol delivery devices and methods described herein can be used to deliver an aerosol to a micron size environment, such as a microfluidic module, a sensor or detector (or array of sensors or detectors), a small animal, an explanted whole organ, cultured organ rudiment, or similar environment.

In one embodiment, the aerosol delivery device and methods described herein can be used to deliver an aerosol to any microfluidic module that comprises at least one microchannel, e.g., including at least 2, 3, 4, 5, 6, 7, 8, 9, 10 or more microchannels or microfluidic channels. Thus, an aerosol delivery microfluidic system comprising one or more embodiments of the aerosol delivery device and at least one or more microfluidic modules is also provided herein. In some embodiments, a microfluidic module can include an elongated microfluidic channel (or microchannel) extending from an inlet port to an outlet port and the feed tube is connected to the inlet port. As used herein, the term “microchannel” or “microfluidic channel” refers to a channel formed in a microfluidic module or device having cross-sectional dimensions in the range between about 0.1 μm and about 1000 μm, between about 1 μm and about 750 μm, or between about 10 μm and about 500 μm. In some embodiments, a microchannel can be a channel present in a micron size environment other than a microfluidic module or device, e.g., but not limited to, a sensor or detector (or array of sensors or detectors), a small animal, an explanted whole organ, cultured organ rudiment, or similar environment.

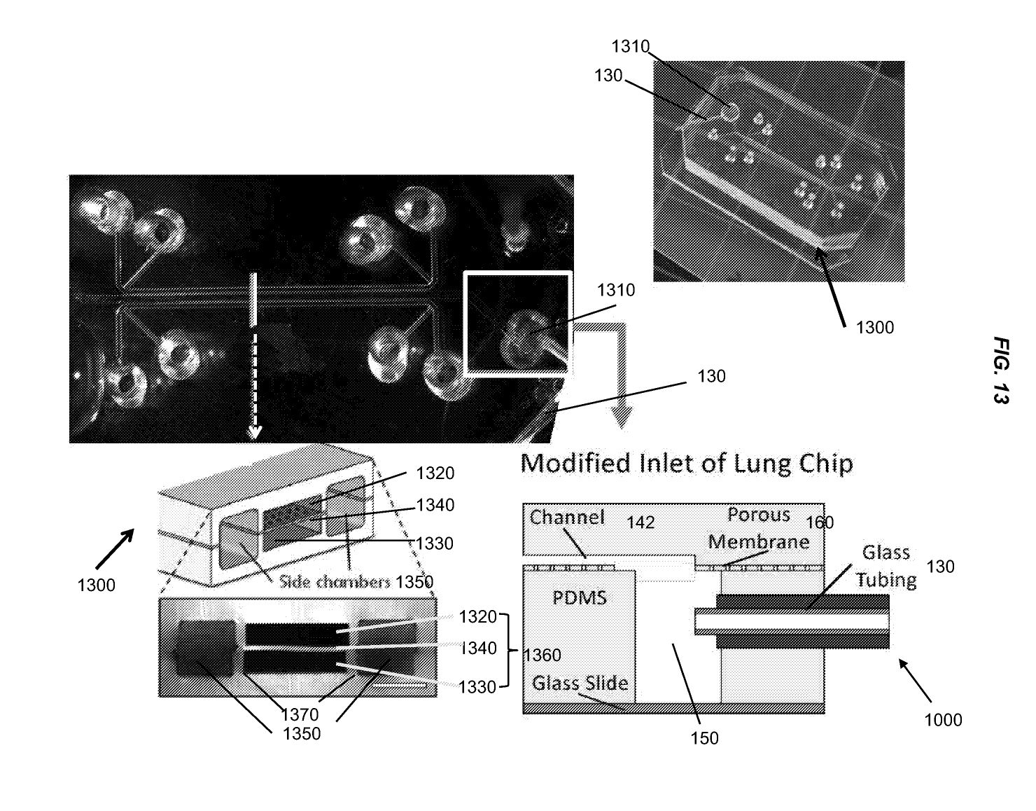

In some embodiments, the microfluidic module can include a biomimetic organ on a chip device, e.g., a lung-on-a-chip device known in the art, or any organ chip where aerosol delivery of an agent is desirable. In some embodiments, for example, as shown in FIG. 13, the biomimetic organ on the chip device 1300 can include at least a first microfluidic channel (e.g., 1360) and a first operating channel (e.g., 1350). The first microfluidic channel 1360 can include an at least partially porous membrane 1340 extending along a plane and dividing the first microfluidic channel 1360 into a first chamber 1320 and a second chamber 1330, wherein the first microfluidic channel 1360 is separated from a first operating channel 1350 by a channel wall 1370 and a pressure differential between the first microfluidic channel 1360 and the first operating channel 1350 causes the channel wall 1370 to flex and causes the porous membrane 1340 to expand or contract along the plane. Some embodiments of such biomimetic organ on a chip device described in the International Patent Application No. WO 2010/009307, the content of which is incorporated herein by reference, can be amenable for use in an aerosol delivery microfluidic system.

In order to adapt the microfluidic module to aerosol delivery, a microchannel of a microfluidic module used for aerosol delivery can be, directly or indirectly, connected to a feed tube 130 (e.g., with or with a particle discriminator or cascading impactor such as an inertial impactor 1000 or 1100 as described herein) that delivers an aerosol from an aerosol producing element 110 (e.g., comprising a nebulizer 112) according to one or more embodiments described herein. By way of example only, as shown in FIG. 13, the top channel 1320 of the microfluidic module or biomimetic organ on the chip device 1300 is desired to be filled with air and used for aerosol delivery of an agent, e.g., to one or more cells (e.g., but not limited to alveolar epithelial cells) cultured on the top surface of the porous membrane 1340, while the bottom channel 1330 is desired to be filled with a liquid media. In some embodiments, the bottom surface of the porous membrane 1340 can be layered with one or more cells (e.g., but not limited to, microvascular endothelial cells). In such embodiment, the top channel inlet 1310 can be directly or indirectly connected to a feed tube 130 (e.g., with or without a particle discriminator or cascading impactor such as an inertial impactor 1000 or 1100 as described herein) that delivers an aerosol from an aerosol producing element 110 (e.g., comprising a nebulizer 112). In some embodiments, at least the top channel inlet 1310 of the microfluidic module or biomimetic organ on the chip device 1300 can be modified to include an inertial impactor as described herein, e.g., inertial impactor 1000 or 1100. For example, as shown in FIG. 13, the top channel inlet 1310 of the microfluidic module or biomimetic organ on the chip device 1300 can be directly or indirectly connected to a feed tube 130 leading into a particle discriminator or cascading impactor such as an inertial impactor 1000. The microchannel 142 (in fluid communication with the chamber 150) and the porous membrane 160 of the inertial impactor 1000 can be directly or indirectly connected to the top channel 1320 and the porous membrane 1340 of the microfluidic module or biomimetic organ on the chip device 1300. For example, in some embodiments, the microchannel 142 (in fluid communication with the chamber 150) and the porous membrane 160 of an inertial impactor 1000 can be a direct extension of the top channel 1320 and the porous membrane 1340 of the microfluidic module or biomimetic organ on the chip device 1300. In some embodiments, the microchannel 142 (in fluid communication with the chamber 150) of an inertial impactor 1000 can be indirectly connected to the top channel 1320 of the microfluidic module or biomimetic organ on the chip device 1300, e.g., via an adapter such as another tubing or microchannel. In such embodiments, a porous membrane can be absent from an inertial impactor 1000.

### Methods of Use

In any aspects described herein, the aerosol producing element can produce an aerosol containing at least one agent, e.g., but not limited to, drugs, therapeutic agents, toxins, cells, bacteria, viruses, particulates, nanoparticles, pollutants, contaminants, biologics, infectious agents, and any combination thereof. Accordingly, methods for delivering an aerosolized agent to a micron size environment, such as a microfluidic module, a sensor or detector (or array of sensors or detectors), a small animal, an explanted whole organ, cultured organ rudiment, or similar environment are provided herein.

In some embodiments, the method can comprise (i) providing one or more embodiments of the aerosol delivery device described herein, (ii) generating an aerosol of an agent of interest with the aerosol producing element; and (iii) flowing the aerosolized agent from the aerosol producing element through the feed tube connecting to the micron size environment (e.g., a microfluidic module), wherein at least a portion of the aerosolized agent flows from the feed tube into a microchannel of the micron size environment (e.g., the microfluidic module) and deposits on at least a portion of a surface of the microchannel. If the agent of interest is a coating solution, the method described herein can be used to coat at least a portion of the surface of the microchannel. Alternatively, if the microchannel comprises at least one cell (e.g., a plurality of cells) cultured on the surface of the microchannel, the aerosolized agent can deposit on said at least one cell (e.g., plurality of cells) cultured on the surface of the microchannel, wherein the cell(s) can then uptake the agent. In some embodiments, when the agent of interest comprises a cell, the method described herein can be used to deposit another layer of cell on the cell(s) present on the surface of the microchannel.

In some embodiments, various aspects described herein can be applied, for example, to a breathing lung-on-a-chip device in order to model and measure pulmonary absorption, efficacy and toxicity of aerosol-based drugs, therapeutic agents, and toxins. Various embodiments described herein can also be applied to other organ on-a-chip devices to model and measure absorption, efficacy and toxicity of aerosol-based drugs, therapeutic agents, biologics, and toxins in airborne environments, or to delivery of particular sized liquid droplets or vesicles. Accordingly, methods for determining an effect of an aerosolized agent on at least one cell in a microfluidic module are also provided herein. Such method comprises (i) providing one or more embodiments of the aerosol delivery device described herein, (ii) generating an aerosol of an agent with the aerosol producing element; (iii) flowing the aerosolized agent from the aerosol producing element through the feed tube connecting to the microfluidic module, wherein at least a portion of the aerosolized agent flows from the feed tube into a microchannel of the microfluidic module and deposits on at least one cell cultured in the microchannel; and (iv) detecting a response of said at least one cell after exposure to the aerosolized agent for a period of time, thereby determining the effect of the aerosolized agent on said at least one cell in the microfluidic module.

In some embodiments, the cell(s) in the microfluidic module can be a normal cell.

In other embodiments, the cell(s) in the microfluidic module can be treated or manipulated, for example, but not limited to, chemically (e.g., with a chemical or protein), genetically (e.g., genetic modification), mechanically (e.g., shear stress, or stretching), or radioactively (e.g., with radiation), to induce a pathological change, e.g., to represent a disease model of interest. Thus, the cell(s) and aerosol delivery device/system described herein can be used to evaluate efficacy or therapeutic potential of a drug candidate or a treatment on the cell.

In any embodiments of the methods described herein, a liquid or solution comprising one or more agents (e.g., at least 1, at least 2, at least 3, at least 4, at least 5 or more agents) can be nebulized or atomized into an aerosol with one or more embodiments of the aerosol producing element described herein. In some embodiments where there is more than 1 agent (e.g., 2, 3, 4, 5, 6, or more agents) to be nebulized or atomized, at least one agent can be nebulized or atomized into an aerosol independently from the others, for example, with a separate aerosol producing element, when needed. The aerosolized droplets of different agents can then be combined together before flowing toward a feed tube and optionally into a flow splitting device, if necessary.

In one embodiment, the aerosol can be generated with a nebulizer (e.g., a commercial nebulizer or any art-recognized nebulizer adapted for use with a microfluidic module). In one embodiment, the aerosol can be generated with a nebulizer connected to an air compressor. Depending on types of an aerosol producing element, the aerosol can be generated with an aerosol producing element at a pressure (e.g., air pressure) ranging from about 0.1 psi to about 100 psi, about 0.5 psi to about 75 psi, about 1 psi to about 50 psi, about 5 psi to about 25 psi, or about 10 psi to about 20 psi.

The aerosolized liquid droplets produced from an aerosol producing element can be of any size. In some embodiments, the aerosolized liquid droplets produced from an aerosol producing element can have a uniform size. In other embodiments, the aerosolized liquid droplets produced from an aerosol producing element can have a distribution of size. For example, the aerosolized liquid droplets produced from an aerosol producing can have a nominal median mass diameter ranging from about 0.01 μm to about 50 μm, about 0.05 μm to about 25 μm, about 0.1 μm to about 15 μm, about 1 μm to about 10 μm, or about 1 μm to about 7 μm.

After generation of aerosol droplets, the aerosol droplets can be directed to flow from the aerosol producing element to a feed tube connecting to a microfluidic module. Depending on the distribution and/or size of aerosol droplets, in some embodiments, it can be desirable to separate larger droplets from smaller droplet using any methods known in the art, e.g., a cascading impactor or particle discriminator, to avoid any large droplets from clogging the feed tube.

In some embodiments, the aerosol generated from an aerosol producing element (e.g., a commercial nebulizer) can have a flow rate and/or pressure too high for delivery to a microfluidic module. Accordingly, in some embodiments, the flow splitting device can comprise one or more valves, e.g., an adjustable valve, such that only a portion of the aerosolized agent (e.g., no more than 60%, no more than 50%, no more than 40%, no more than 30%, no more than 20%, no more than 10% or lower, of the aerosolized agent generated from the aerosol producing element) flows into the feed tube connecting to a microfluidic module. In some embodiments, the

[symbol]

In some embodiments, the valve(s) of the flow splitting device can be adjusted such that the flow rate of an aerosol into a microfluidic module can range from about 0.5 mL/hr to about 100 mL/hr, from about 1 mL/hr to about 75 mL/hr, from about 5 mL/hr to about 50 mL/hr, or from about 10 mL/hr to about 30 mL/hr. In other embodiments, the valve(s) of the flow splitting device can be adjusted such that the flow rate of an aerosol into a microfluidic module generates a shear stress of no more than 20 dynes/cm², no more than 15 dynes/cm², no more than 10 dynes/cm², no more than 5 dynes/cm², no more than 1 dyne/cm² or lower. In one embodiment, when there are cells cultured at an air interface inside a microchannel along which an aerosol is flowing, the flow rate of the aerosol should be adjusted such that it does not generate a shear stress that would affect cell response or behavior. In some embodiments, the flow rate of the aerosol can be adjusted to produce a shear stress of less than 1 dyne/cm², e.g., for some epithelial cells. However, in some embodiments, a flow rate of the aerosol that produces a larger shear stress (e.g., more than 1 dyne/cm²) can also be used, provided that the cells can tolerate larger shear stress. In some embodiments, depending on various applications of the aerosol delivery device and/or system, e.g., to create a disease model, a flow rate of the aerosol that produces a shear stress sufficient to affect cell response or behavior (e.g., but not limited to, cell alignment and/or morphology, gene expression, cell adhesion, cell migration, cell junction, mechanical properties of cells such as cell stiffness) can be used.

In some embodiments, the flow rate of an aerosol flowing in the microfluidic module is adjusted such that an aerosol can have sufficient residence time to deposit on at least a portion of a surface of the microchannel. In some embodiments, when the microchannel comprises at least one cell (e.g., at least 1, at least 2, at least 3, at least 4, at least 5, at least 10, at least 20, at least 30, at least 40, at least 50, at least 100, at least 500, at least 1000, or more cells) cultured on the surface thereon, the aerosolized agent can deposit on at least a portion (e.g., at least about 30%, at least about 40%, at least about 50%, at least about 60%, at least about 70%, at least about 80%, at least about 90%, at least about 95% or more) of the cultured cells. In one embodiment, the aerosolized agent can deposit on all of the cultured cells.

In some embodiments, the flow rate of an aerosol flowing in the microfluidic module can be adjusted such that there is an even deposition of the aerosol on at least a portion of a surface of a microchannel, or at least a portion of the cells cultured on the surface of the microchannel.

In some embodiments, the aerosol flowing from the feed tube can be introduced into a certain portion or region of a microchannel of a microfluidic module, e.g., for selective or localized aerosol deposition on the certain portion of the microchannel. For example, instead of having the aerosol flowing from the channel main inlet, there can be one or more ports (e.g., sealable ports) along the top surface of the microchannel, such that the aerosol flowing from the feed tube can be connected to a micro-tubing or a flexible tubing inserted into at least one of those ports for delivering the aerosolized agent to the region of interest. In some embodiments, the methods described herein can deposit more aerosolized agent on a bottom surface of the microchannel than on a top surface of the microchannel. In some embodiments, the methods described herein can deposit more aerosolized agent on at least a portion of the cells on the bottom surface of the microchannel than on a top surface of the microchannel.

The aerosol delivery devices/systems and methods described herein can have many different applications or be used for determining an effect of an aerosolized agent on at least one cell, including, but not limited to, identification of markers of disease; assessing efficacy of anti-cancer therapeutics; testing gene therapy vectors; drug development; screening; studies of cells, especially stem cells and bone marrow cells; studies on biotransformation, absorption, clearance, metabolism, and activation of xenobiotics; studies on bioavailability and transport of chemical or biological agents across epithelial or endothelial layers; studies on transport of biological or chemical agents across the blood-brain barrier; studies on transport of biological or chemical agents across the intestinal epithelial barrier; studies on acute basal toxicity of chemical agents; studies on acute local or acute organ-specific toxicity of chemical agents; studies on chronic basal toxicity of chemical agents; studies on chronic local or chronic organ-specific toxicity of chemical agents; studies on teratogenicity of chemical agents; studies on genotoxicity, carcinogenicity, and mutagenicity of chemical agents; detection of infectious biological agents and biological weapons; detection of harmful chemical agents and chemical weapons; studies on infectious diseases; studies on the efficacy of chemical or biological agents to treat disease; studies on the optimal dose range of agents to treat disease; prediction of the response of organs in vivo to biological agents; prediction of the pharmacokinetics of chemical or biological agents; prediction of the pharmacodynamics of chemical or biological agents; studies concerning the impact of genetic content on response to agents; studies on gene transcription in response to chemical or biological agents; studies on protein expression in response to chemical or biological agents; studies on changes in metabolism in response to chemical or biological agents. The aerosol delivery devices/systems and methods described herein can also be used to screen on the cells, for an effect of the cells on the materials (for example, in a manner equivalent to tissue metabolism of a drug).

In these embodiments, at least one type of cells (including at least 2 types of cells, e.g., in a co-culture, or more than 2 types of cells) can be cultured in a microfluidic module to model the microenvironment of interest or a disease or disorder of interest. One of skill in the art can readily culture different kind of cells in a microfluidic module, and to form a biomimetic organ on a chip, e.g., lung-on-a-chip and other organs on chips described in the International Application No. WO 2010/009307, the content of which is incorporated herein by reference.

Different types of cell responses after exposure to the aerosolized agent for a period of time (e.g., from minutes, to hours, to days, to weeks) can be detected in accordance with various applications or effects to be evaluated. For example, to determine toxicity of an aerosolized agent (e.g., a drug, a therapeutic agent, or particulates, e.g., nanoparticles) on cells, cell viability can be measured after exposing the cells to the aerosolized agent for a period of time. Methods for detecting cell viability are known in the art, including, but not limited to, staining live cells with a marker (e.g., a fluorescein marker) that can only be up-taken by live cells, and then viewing or monitoring them with imaging tools, such as fluorescence microscopy, microfluorimetry or optical coherence tomography (OCT) for real-time analysis of cellular behavior.

In other embodiments, to determine a therapeutic response of a drug on a disease model (e.g., pulmonary edema) in a microfluidic module, detection of a cell response can include, but are not limited to, detecting or measuring the change in a level of a biomarker associated with the disease, changes in gene expression of cells, and/or changes in cell behavior or morphology/phenotype. Exemplary detection methods of different cell responses described in the International Application No. WO 2010/009307, the content of which is incorporated herein by reference, can be used in the methods described herein.

### Substances or Agents Amenable to Aerosol Delivery Using the Devices or Systems and Methods Described Herein

In accordance with the various embodiments described herein, the aerosol can include a broad range of substances including drugs, therapeutic agents, biological agents and toxins, particulates (including nanoparticles) as well as mixtures and combinations thereof. In accordance with some embodiments described herein, examples can include drugs selected from the drug classes including steroids, anti-inflammatories, antibiotics, anti-cancer, immune adjuvants, anti-arrythmia, inotropic, anesthetic, neuroleptic, anti-diabetic, and biological agents. Other examples of drug compounds and classes that can be delivered by various embodiments described herein include dexamethasone, budesonide, beclomethasone dipropionate, corticosteroids, biologics, chemotherapeutics, doxorubicin, irinotecan, gemcitabine, paclitaxel, docetaxel, bleomycin, and Doxil. In accordance with various aspects described herein, further examples can include therapeutic agents selected from the classes of therapeutic agents including antibodies, liposomes, nucleic acids, proteins, RNAi, micro RNAs, siRNA and other biologics, nanoparticles, macromolecules, nanoparticle-drug conjugates, or small chemicals. In accordance with some embodiments described herein, other examples can include toxins selected from the classes of toxins including neurotoxins, biological toxins, nanoparticles, environmental toxins, environmental pollutants, diesel exhausts, cytokines, venoms, bacterial-produced toxins, radicals, hydrogen peroxide and smoke.

In accordance with other embodiments described herein, the device/system and method can be used to deliver aerosol based substances to small animals, cells and cell cultures, tissues and tissue cultures, and organs for diagnostic, therapeutic and toxicity examinations.

In accordance with an alternate embodiment, the device/system and method can also be used to deliver small aerosols of substrates, reactants, catalysts, or enzymes to systems where one desires size or spatial control on millimeter or micron scale.

In accordance with an alternate embodiment, the device/system and method can also be used to deliver aerosols of substrates, reactants, catalysts, or enzymes to particle sizers (e.g., particle discriminator), analytical systems and devices (e.g. mass spectrometers, fluorimeters, PCR systems and gene analyzers/etc.), as well as imaging system (e.g. optical imaging systems, ultrasonic, and magnetic imaging).

In accordance with an alternate embodiment, the device/system and method can also be used to deliver aerosols of bacteria, viruses, particulates (including nanoparticles), pollutants, contaminants, biologics, or infectious agents for use in detection systems, for the detection of, for example, bacteria, pollutants, contaminants, biologics and infectious agents.

Exemplary embodiments of the aerosol delivery device/system and methods of use can be also described by any one of the following numbered paragraphs.
1. An aerosol delivery device for delivering an aerosol to a microfluidic module, the device comprising:
   an aerosol producing element; and
   a feed tube having an inner channel adapted to connect the aerosol producing element to the microfluidic module, wherein the aerosol can flow from the aerosol producing element into at least one microchannel of the microfluidic module.
2. The aerosol delivery device of paragraph 1, wherein the inner channel of the feed tube is treated to reduce the contact angle of the aerosol in the feed tube.
3. The aerosol delivery device of paragraph 1 or 2, wherein the inner channel of the feed tube is plasma cleaned.
4. The aerosol delivery device of any of paragraphs 1-3, wherein the feed tube is treated to oxidize the inner channel.
5. The aerosol delivery device of any of paragraphs 1-4, wherein the feed tube is treated to covalently bond polar moieties to the inner channel.
6. The aerosol delivery device of any of paragraphs 1-5, wherein the feed tube is treated to deposit a thin layer of a polar compound on the inner channel.
7. The aerosol delivery device of any of paragraphs 1-6, further comprising a well at the end of the feed tube to collect an aerosol fluid draining from the feed tube as it enters the microfluidic module.
8. The aerosol delivery device of any of paragraphs 1-7, wherein the inner channel has a diameter of about 10 μm to about 10,000 μm.
9. The aerosol delivery device of any of paragraphs 1-8, wherein the inner channel has a diameter of about 50 μm to about 500 μm, or about 100 μm to about 300 μm.
10. The aerosol delivery device of any of paragraphs 1-9, wherein the feed tube includes a glass tube.
11. The aerosol delivery device of any of paragraphs 1-10, wherein the aerosol producing element comprises a nebulizer.
12. The aerosol delivery device of any of paragraphs 1-11, further comprising a flow splitting device defining a flow path connected to the aerosol producing element and adapted to guide the aerosol along the flow path to the feed tube.
13. The aerosol delivery device of paragraph 12, wherein the flow splitting device is adapted to be capable of controlling a flow rate of the aerosol passing through the feed tube.
14. The aerosol delivery device of any of paragraphs 1-13, further comprising a chamber in fluid communication with said at least one microchannel, wherein the chamber comprises:
   an aerosol inlet for entry of at least a portion of the aerosol produced from the aerosol producing element;
   a capture surface opposing to the aerosol inlet, wherein the capture surface is placed at a pre-determined distance apart from the aerosol inlet such that one or more large droplets of the aerosol are collected on the capture surface, while one or more small droplets of the aerosol are capable of flowing into said at least one microchannel; and
   an outlet adaptably connected to said at least one microchannel, wherein the outlet is placed relative to the aerosol inlet such that the aerosol flows from the aerosol inlet defining an axis to the outlet at an angle between about zero degrees and about 180 degrees relative to the axis.
15. The aerosol delivery device of paragraph 14, wherein the aerosol inlet is adaptably connected to the aerosol producing element.
16. The aerosol delivery device of paragraph 14, wherein the aerosol inlet is adaptably connected to the feed tube.
17. The aerosol delivery device of paragraph 14, wherein the aerosol inlet is adaptably connected to the flow-splitting device.
18. The aerosol delivery device of any of paragraphs 1-17, wherein said least one microchannel further comprises at least one micro-post disposed therein for further size separation.
19. The aerosol delivery device of any of paragraphs 1-18, wherein the feed tube delivers the aerosol from the side of the microfluidic module.
20. The aerosol delivery device of any of paragraphs 1-19, wherein the feed tube delivers the aerosol from the top of the microfluidic module.
21. The aerosol delivery device of any of paragraphs 1-20, wherein feed tube delivers the aerosol from the bottom of the microfluidic module.
22. The aerosol delivery device of any of paragraphs 1-21, wherein the microfluidic module includes a biomimetic organ on a chip device.
23. The aerosol delivery device of paragraph 22, wherein the biomimetic organ on the chip device includes a lung-on-a-chip device;
24. The aerosol delivery device of paragraph 22 or 23, wherein the biomimetic organ on the chip device includes at least a first microfluidic channel and a first operating channel;
   the first microfluidic channel including an at least partially porous membrane extending along a plane and dividing the first microfluidic channel into a first chamber and a second chamber;
   wherein the first microfluidic channel is separated from the first operating channel by a channel wall and a pressure differential between the first microfluidic channel and the first operating channel causes the channel wall to flex and causes the porous membrane to expand or contract along the plane.
25. The aerosol delivery device of any of paragraphs 1-24, wherein the microfluidic module includes an elongated microfluidic channel extending from an inlet port to an outlet port.
26. The aerosol delivery device of paragraph 25, wherein the feed tube is connected to the inlet port of the microfluidic module.
27. The aerosol delivery device of any of paragraphs 1-26, wherein the aerosol producing element produces an aerosol containing at least one of the following drugs or drug classes, including steroids, anti-inflammatory drugs, antibiotics, anti-cancer, immune adjuvants, anti-arrythmia, inotropic, anesthetic, neuroleptic, anti-diabetic, biological agents, dexamethasone, budesonide, beclomethasone dipropionate, corticosteroids, biologics, chemotherapeutics, doxorubicin, irinotecan, gemcitabine, paclitaxel, docetaxel, bleomycin, and doxil.
28. The aerosol delivery device of any of paragraphs 1-27, wherein the aerosol producing element produces an aerosol containing at least one of the following therapeutic agents, including steroids, anti-inflammatories, antibiotics, anti-cancer, immune adjuvants, anti-arrythmia, inotropic, anesthetic, neuroleptic, anti-diabetic, biological agents, antibodies, liposomes, nucleic acids, RNAi, biologics, nanoparticles, proteins, macromolecules, nanoparticle-drug conjugates, and small chemicals.
29. The aerosol delivery device of any of paragraphs 1-28, wherein the aerosol producing element produces an aerosol containing at least one of the following toxins or classes of toxins, including neurotoxins, biological toxins, nanoparticles, environmental toxins, environmental pollutants, particulates, diesel exhausts, cytokines, venoms, bacterial-produced toxins, radicals, hydrogen peroxide, and smoke.
30. The aerosol delivery device of any of paragraphs 1-29, wherein the aerosol producing element produces an aerosol containing at least one of the following classes of agents, including cells, bacteria, viruses, particulates, pollutants, contaminants, biologics, or infectious agents.
31. A method for delivering an aerosolized agent to a microfluidic module, the method comprising:
   providing
      an aerosol producing element; and
      a feed tube having an inner channel adapted to connect the aerosol producing element to the microfluidic module;
   generating an aerosol of an agent with the aerosol producing element;
   flowing the aerosolized agent from the aerosol producing element through the feed tube connecting to the microfluidic module, wherein at least a portion of the aerosolized agent flows from the feed tube into a microchannel of the microfluidic module and deposits on at least a portion of a surface of the microchannel.
32. The method of paragraph 31, wherein more aerosolized agent deposits on a bottom surface of the microchannel than on a top surface of the microchannel.
33. The method of paragraph 31 or 32, wherein the microchannel comprises at least one cell on the surface of the microchannel, and the aerosolized agent deposits on said at least one cell on the surface of the microchannel.
34. A method for determining an effect of an aerosolized agent on at least one cell in a microfluidic module, the method comprising:
   providing
      an aerosol producing element; and
      a feed tube having an inner channel adapted to connect the aerosol producing element to the microfluidic module;
   generating an aerosol of an agent with the aerosol producing element;
   flowing the aerosolized agent from the aerosol producing element through the feed tube connecting to the microfluidic module, wherein at least a portion of the aerosolized agent flows from the feed tube into a microchannel of the microfluidic module and deposits on at least one cell in the microchannel; and
   detecting a response of said at least one cell after exposure to the aerosolized agent for a period of time, thereby determining the effect of the aerosolized agent on said at least one cell in the microfluidic module.
35. The method of any of paragraphs 31-34, wherein the inner channel of the feed tube is treated to reduce the contact angle of the aerosol in the feed tube.
36. The method of any of paragraphs 31-35, wherein the inner channel of the feed tube is plasma cleaned.
37. The method of any of paragraphs 31-36, wherein the feed tube is treated to oxidize the inner channel.
38. The method of any of paragraphs 31-37, wherein the feed tube is treated to covalently bond polar moieties to the inner channel.
39. The method of any of paragraphs 31-38, wherein the feed tube is treated to deposit a thin layer of a polar compound on the inner channel.
40. The method of any of paragraphs 31-39, wherein the inner channel has a diameter of about 10 μm to about 10,000 μm.
41. The method of any of paragraphs 31-40, wherein the inner channel has a diameter of about 50 μm to about 500 μm, or about 100 μm to about 300 μm.
42. The method of any of paragraphs 31-41, wherein the feed tube includes a glass tube.
43. The method of any of paragraphs 31-42 wherein the aerosol producing element comprises a nebulizer.
44. The method of any of paragraphs 31-43, further comprising a flow splitting device defining a flow path connected to the aerosol producing element and adapted to guide the aerosol along the flow path to the feed tube.
45. The method of paragraph 44, wherein the flow splitting device is adapted to be capable of controlling a flow rate of the aerosol passing through the feed tube into the microchannel.
46. The method of paragraph 45, wherein the flow rate of the aerosol introduced into the microchannel is about 500 μL/hr to about 100 mL/hr or about 5 mL/hr to about 50 mL/hr.
47. The method of paragraph 45, wherein the flow rate of the aerosol introduced into the microchannel is about 20 mL/hr.
48. The method of any of paragraphs 31-47, further comprising a chamber in fluid communication with the microchannel, wherein the chamber comprises:
   an aerosol inlet for entry of at least a portion of the aerosol produced from the aerosol producing element;
   a capture surface opposing to the aerosol inlet, wherein the capture surface is placed at a pre-determined distance apart from the aerosol inlet such that one or more large droplets of the aerosol are collected on the capture surface, while one or more small droplets of the aerosol are capable of flowing into the microchannel; and
   an outlet adaptably connected to the microchannel, wherein the outlet is placed relative to the aerosol inlet such that the aerosol flows from the aerosol inlet defining an axis to the outlet at an angle between about zero degrees and about 180 degrees relative to the axis.
49. The method of paragraph 48, wherein the aerosol inlet is adaptably connected to the aerosol producing element.
50. The method of paragraph 48, wherein the aerosol inlet is adaptably connected to the feed tube.
51. The method of paragraph 48, wherein the aerosol inlet is adaptably connected to the flow-splitting device.
52. The method of any of paragraphs 31-51, wherein the microchannel further comprises at least one micro-post disposed therein for further size separation.
53. The method of any of paragraphs 31-52, wherein the microfluidic module includes a biomimetic organ on a chip device.
54. The method of paragraph 53, wherein the biomimetic organ on the chip device includes a lung-on-a-chip device.
55. The method of paragraph 53 or 54, wherein the biomimetic organ on the chip device includes at least a first microfluidic channel and a first operating channel;

the first microfluidic channel including an at least partially porous membrane extending along a plane and dividing the first microfluidic channel into a first chamber and a second chamber;

wherein the first microfluidic channel is separated from the first operating channel by a channel wall and a pressure differential between the first microfluidic channel and the first operating channel causes the channel wall to flex and causes the porous membrane to expand or contract along the plane.
56. The method of any of paragraphs 31-55, wherein the microfluidic module includes an elongated microfluidic channel extending from an inlet port to an outlet port.
57. The method of paragraph 56, wherein the feed tube is connected to the inlet port of the microfluidic module.
58. The method of any of paragraphs 31-57, wherein the agent comprises at least one of the following drugs or drug classes, including steroids, anti-inflammatory drugs, antibiotics, anti-cancer, immune adjuvants, anti-arrythmia, inotropic, anesthetic, neuroleptic, anti-diabetic, biological agents, dexamethasone, budesonide, beclomethasone dipropionate, corticosteroids, biologics, chemotherapeutics, doxorubicin, irinotecan, gemcitabine, paclitaxel, docetaxel, bleomycin, and doxil.
59. The method of any of paragraphs 31-58, wherein the agent comprises at least one of the following therapeutic agents, including steroids, anti-inflammatories, antibiotics, anti-cancer, immune adjuvants, anti-arrythmia, inotropic, anesthetic, neuroleptic, anti-diabetic, biological agents, antibodies, liposomes, nucleic acids, RNAi, biologics, nanoparticles, proteins, macromolecules, nanoparticle-drug conjugates, and small chemicals.
60. The method of any of paragraphs 31-59, wherein the agent comprises at least one of the following toxins or classes of toxins, including neurotoxins, biological toxins, nanoparticles, environmental toxins, environmental pollutants, particulates, diesel exhausts, cytokines, venoms, bacterial-produced toxins, radicals, hydrogen peroxide, and smoke.
61. The method of any of paragraphs 31-60, wherein the agent comprises at least one of the following classes of agents, including cells, bacteria, viruses, particulates, pollutants, contaminants, biologics, or infectious agents.

### SOME SELECTED DEFINITIONS

Unless defined otherwise, all technical and scientific terms used herein have the same meaning as those commonly understood to one of ordinary skill in the art to which this invention pertains. Although any known methods, devices, and materials can be used in the practice or testing of the invention, the methods, devices, and materials in this regard are described herein.

For convenience, certain terms employed herein, in the specification, examples and appended claims are collected herein. Unless stated otherwise, or implicit from context, the following terms and phrases include the meanings provided below. Unless explicitly stated otherwise, or apparent from context, the terms and phrases below do not exclude the meaning that the term or phrase has acquired in the art to which it pertains. The definitions are provided to aid in describing particular embodiments, and are not intended to limit the claimed invention, because the scope of the invention is limited only by the claims. Further, unless otherwise required by context, singular terms shall include pluralities and plural terms shall include the singular.

It should be understood that this invention is not limited to the particular methodology, protocols, and reagents, etc., described herein and as such may vary. The terminology used herein is for the purpose of describing particular embodiments only, and is not intended to limit the scope of the present invention, which is defined solely by the claims.

As used herein the term “comprising” or “comprises” is used in reference to compositions, methods, and respective component(s) thereof, that are useful in an embodiment described herein, yet open to the inclusion of unspecified elements, whether useful or not for the embodiment.

As used herein and in the claims, the singular forms “a”, “an” and “the” include the plural reference and vice versa unless the context clearly indicates otherwise. Other than in the operating examples, or where otherwise indicated, all numbers expressing quantities of ingredients or reaction conditions used herein should be understood as modified in all instances by the term “about.”

The term “statistically significant” or “significantly” refers to statistical significance and generally means a two standard deviation (2SD) below normal, or lower, concentration of the marker. The term refers to statistical evidence that there is a difference. It is defined as the probability of making a decision to reject the null hypothesis when the null hypothesis is actually true. The decision is often made using the p-value.

The term “derivative” as used herein refers to a chemical substance related structurally to another, i.e., an “original” substance, which can be referred to as a “parent” compound. A “derivative” can be made from the structurally-related parent compound in one or more steps. The phrase “closely related derivative” means a derivative whose molecular weight does not exceed the weight of the parent compound by more than 50%. The general physical and chemical properties of a closely related derivative are also similar to the parent compound.

The following examples illustrate some embodiments and aspects of the invention. It will be apparent to those skilled in the relevant art that various modifications, additions, substitutions, and the like can be performed without altering the spirit or scope of the invention, and such modifications and variations are encompassed within the scope of the invention as defined in the claims which follow. The following examples do not in any way limit the invention.

### EXAMPLES

### Example 1

### Aerosol Delivery to a Microfluidic Device

This example shows an exemplary system for delivering microscale liquid droplets to a microfluidic device (e.g., a polydimethylsiloxane (PDMS) microfluidic device) with at least one microchannel. For example, the exemplary system can be used to deliver microscale liquid droplets to an “air culture” channel of a lung-on-a-chip as described in Huh et al. “Reconstituting Organ-Level Lung Functions on a Chip,” Science (2010) 328: 1662-1668. In one embodiment of a lung-on-a-chip, two microchannels (e.g., 80×200 μm channels) used for applying static or cyclic mechanical distortion, e.g., by suction, can be placed on one or both sides of a central channel (e.g., 80×400 μm channel). The central channel can have a porous flexible membrane (e.g., PDMS membrane) separating the central channel into an upper microchannel (e.g., an “air culture” channel”) and a lower microchannel. Cells can be placed on at least one side of the porous flexible membrane. In some embodiments, human alveolar epithelial cells can be placed on one side of the porous flexible membrane, while capillary endothelial cells can be placed on another side of the porous flexible membrane.

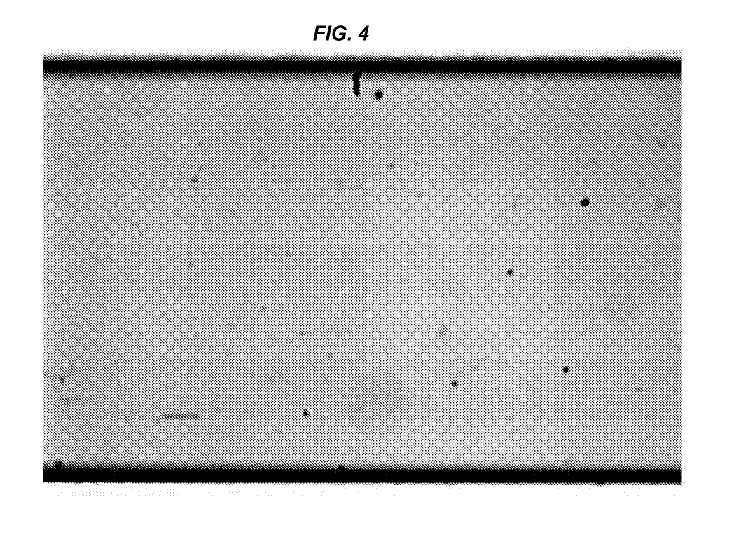

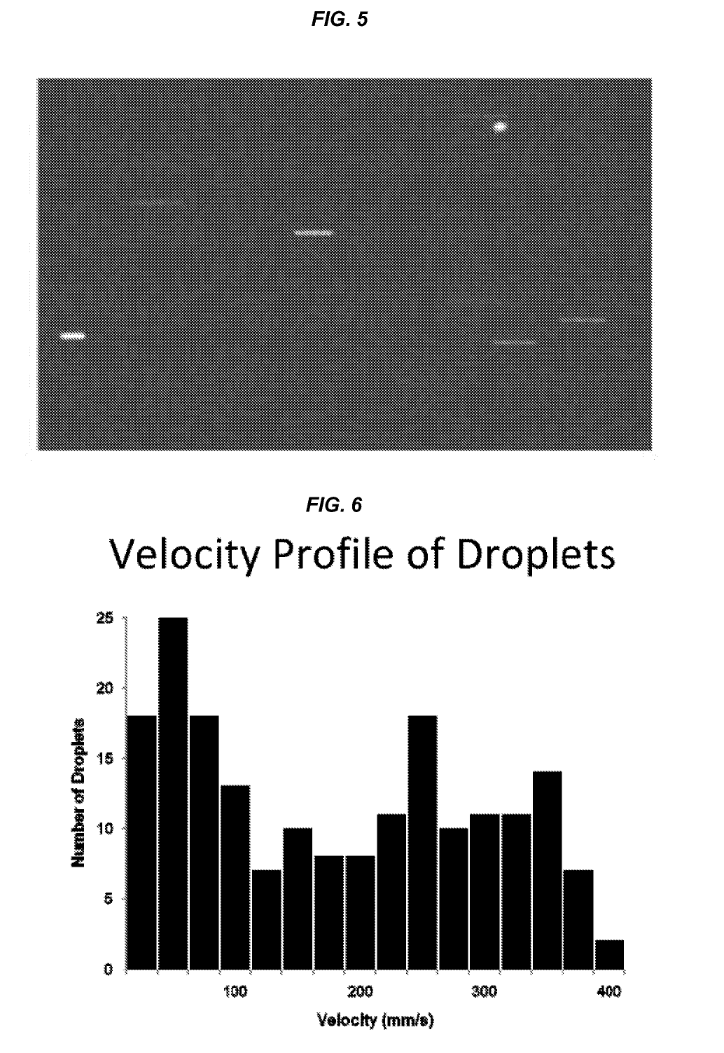

To characterize liquid microdroplets delivered to a microfluidic device, in one embodiment, a PDMS device with microchannel dimensions identical to the “air culture” channel of the lung-on-a-chip was used. The top PDMS channel of the lung-on-a-chip was bonded to a 100-μm-thick glass coverslip. FIGS. 1-2 show an example of an aerosol delivery system according to one or more embodiments provided herein. An aerosol producing element 110 (e.g., comprising a nebulizer 112) can be connected to a microfluidic channel of a microfluidic module 140 (e.g., a microfluidic device), e.g., via a flow splitting device 120 and a feed tube 130 connecting between the microfluidic channel and the flow splitting device 120. In one embodiment, a commercial prescription nebulizer 112 (e.g., obtained from PARI Respiratory Equipment, Inc.) was used to generate aerosolized liquid droplets with a nominal median mass diameter of 3.8 μm by forcing air, e.g., from an air compressor, through an orifice. While in this example pure water droplets were generated, droplets of almost any solution (e.g., an aqueous solution) can be generated with an aerosol producing element 110 (e.g., comprising a nebulizer 112). The liquid droplets in air can be sampled with a feed tube 130 (e.g. glass capillary such as fused silica tubing with an inner diameter of about 100-300 μm) inserted into the flow from the nebulizer (FIG. 3) and flow through the feed tube 130 into a microfluidic channel (e.g., an 80-μm-deep, 400-μm-wide microfluidic channel). The suspended droplets passing through the microchannel, e.g., from a feed tube with an inner diameter of about 100 μm, were imaged on a microscope (e.g., an inverted microscope) and captured with a camera set to 0.1 ms exposure time to characterize their size and velocity distribution (FIG. 4—Brightfield, FIG. 5—Brightfield with average background subtracted), e.g., by processing the captured images using an image-processing algorithm such as ImageJ software.

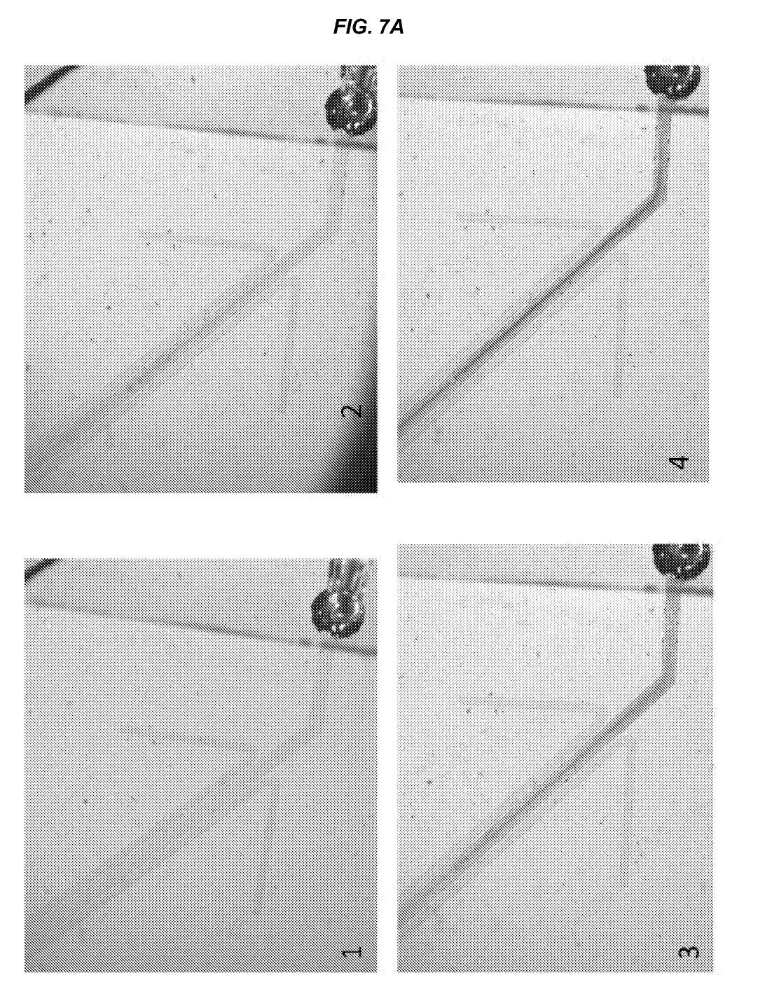

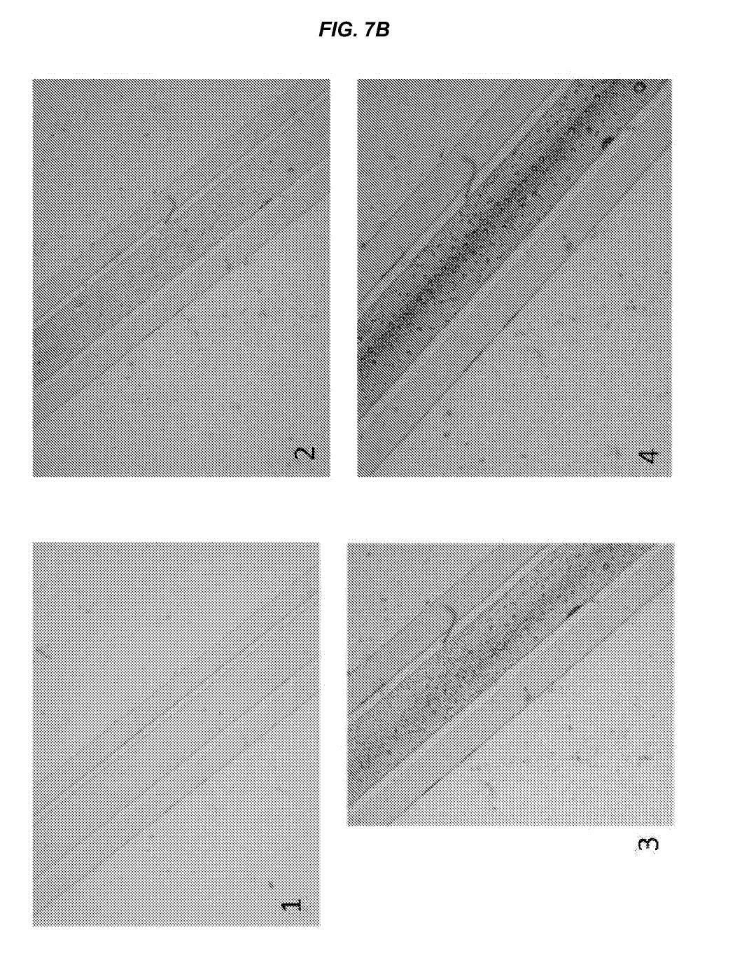

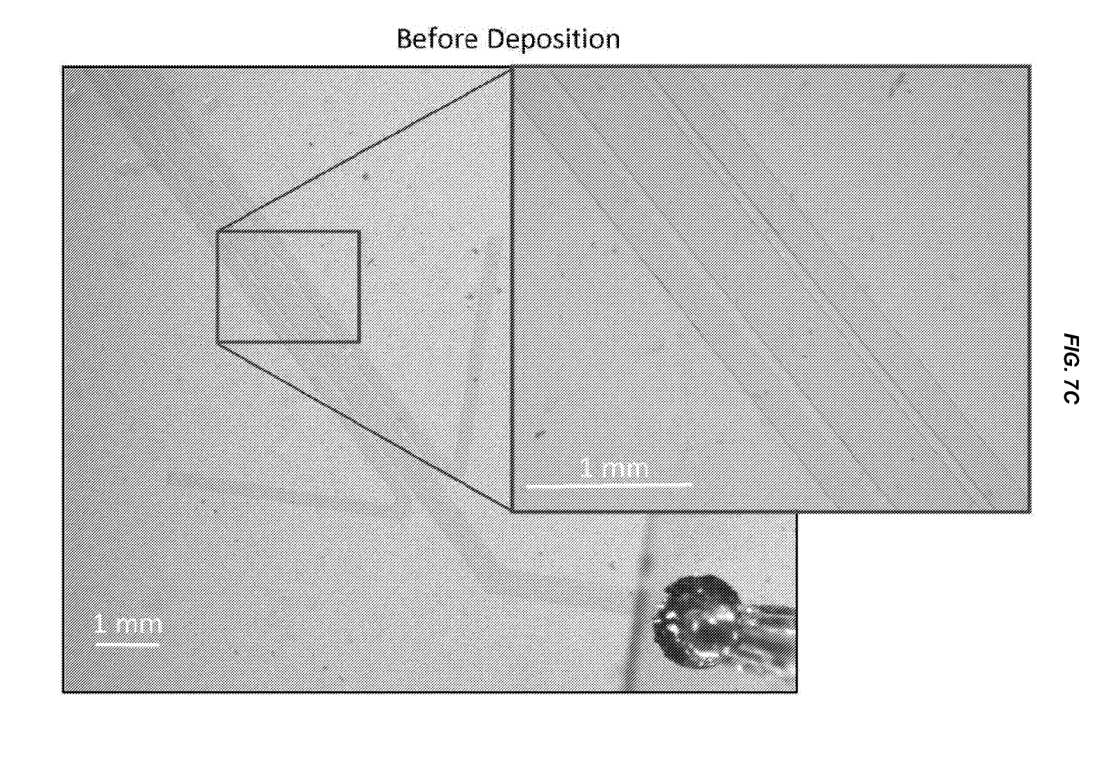

As shown in FIG. 6, the histogram shows the distribution of velocities of individual droplets through the microchannel. The distribution is fairly broad with main peaks at approximately 25 mm/s and 250 mm/s. Any air velocity can be selected in accordance with various applications. For example, an air velocity can be selected not to interfere with cells, if any, cultured at an air interface inside the microfluidic channel. Air velocity of about 250 mm/s in the microchannel of this Example (e.g., an 80-μm-deep, 400-μm-wide microfluidic channel) can result in a shear stress of approximately 3 dynes/cm². The droplets flowing through the microfluidic channel can have a broad size distribution with an average diameter of approximately 7 μm. In some embodiments, the droplets flowing through the microfluidic channel can have a broad size distribution with an average diameter of less than 7 μm. As the droplets suspended in air travel through the microchannel, some of them are deposited on one or more inner surfaces surrounding the microchannel (e.g., one or more microchannel walls) (FIGS. 7A-7D). FIG. 7A shows the deposition process along the length of over half of the channel using a feed tube with an inner diameter of about 100 μm, and FIGS. 7B-7D shows the same time points with the portion of the channel at a higher magnification. A larger feed tube (e.g., 300 μm inner diameter) can also be used to deliver droplets throughout the length of the channel (Data not shown). This indicates that the exemplary aerosol delivery system described herein can be used to deliver an aerosolized drug to one or more cells cultured on a surface of a microchannel or on a surface of the porous flexible membrane situated along a plane of a microchannel, e.g., as in a lung-on-a-chip. The bright field images of the channel before (FIGS. 7A, 7C) and after (FIGS. 7B, 7D) deposition of water droplets show an even distribution along the channel. This is the first demonstration of aerosol delivered to a microfluidic device.

Water was subsequently removed from the nebulizer and unhumidified air was passed through the nebulizer and feed tube (e.g., a capillary tube) into the microchannel at the same flow rate as previously used with water. The droplets previously deposited on the microchannel evaporated after 10 mins under dry air flow (data not shown).

Accordingly, using some embodiments of the method and/or aerosol delivery system described herein, drugs and toxins can be administered to cells (e.g., human cells) cultured at air interface in one or more microfluidic channels. In some embodiments, the design of a microfluidic channel can be adapted to closely mimic an in vivo mechanical and structural environment, e.g., of the human lung alveolar-capillary interface. Id. Aerosol drug delivery to microfluidic cell culture devices can thus provide a more accurate model for drug or particle efficacy and toxicity screening and prediction of their effects in humans.

### Example 2

### Exemplary Modifications of an Aerosol Delivery Device/System Described Herein

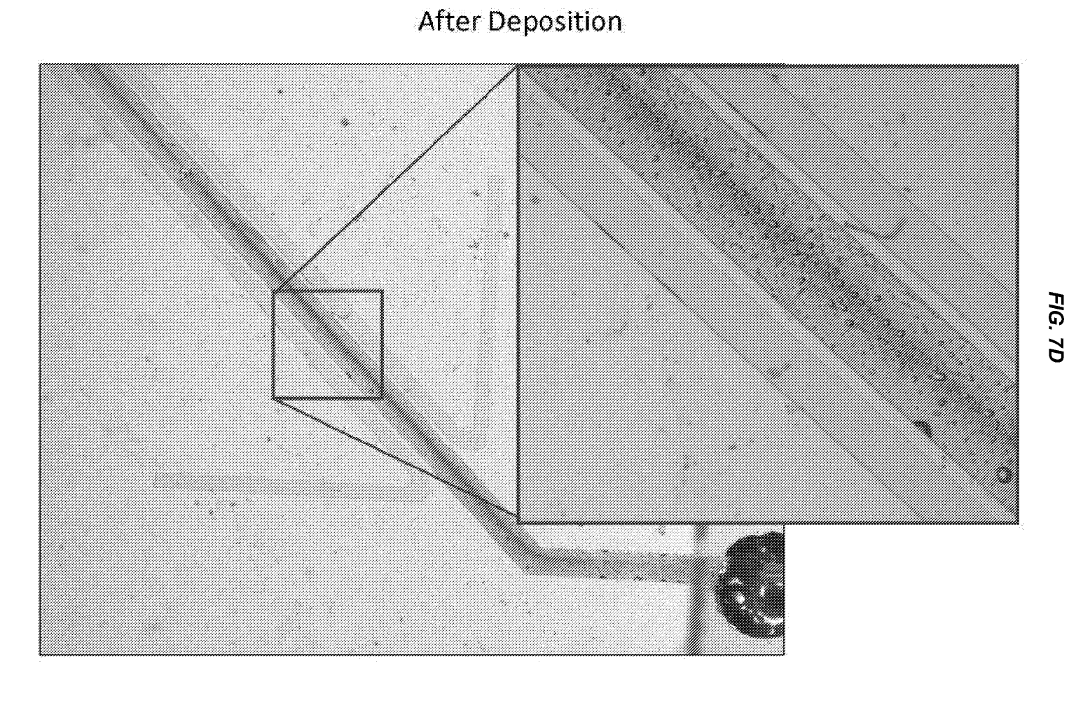

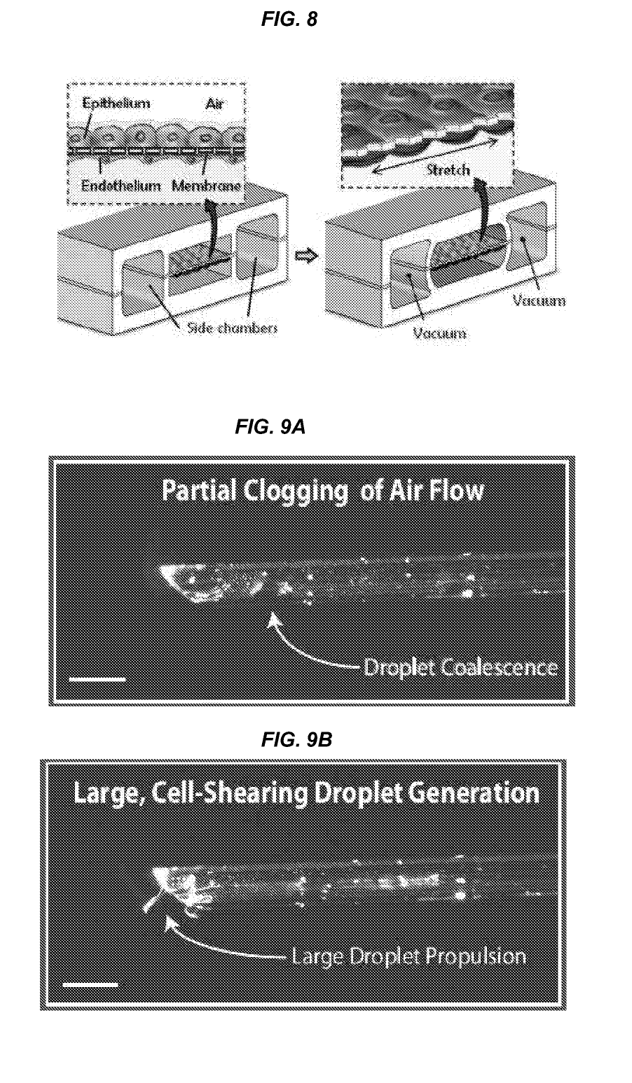

Animal models for drug toxicity and efficacy are expensive and often do not accurately reflect the human response, resulting in wasteful clinical trials and ineffective drug development. Expanding human cell culture systems to microenvironments that mimic in vivo organ-level function can increase human relevance and translation of products to patients. Presented herein is a method of delivering aerosolized drug to a biomimetic microfluidic device or “Lung-on-a-Chip,” for example, the one shown in FIG. 8 (see, e.g., D. Huh, B. D. Matthews, et al., “Reconstituting Organ-Level Lung Functions on a Chip,” Science, 328, pp. 1662-1668, 2010) or the one described in the International Patent Application WO 2010/009307, the content of which is incorporated herein by reference, which can reproduce the alveolar-capillary interface of the human lung under physiologically relevant cyclic mechanical strain and flow conditions. In this Example, an aerosol delivery device/system was modified to improve deposition of aerosol into a microfluidic channel.

Surface Modification of a Feed Tube:

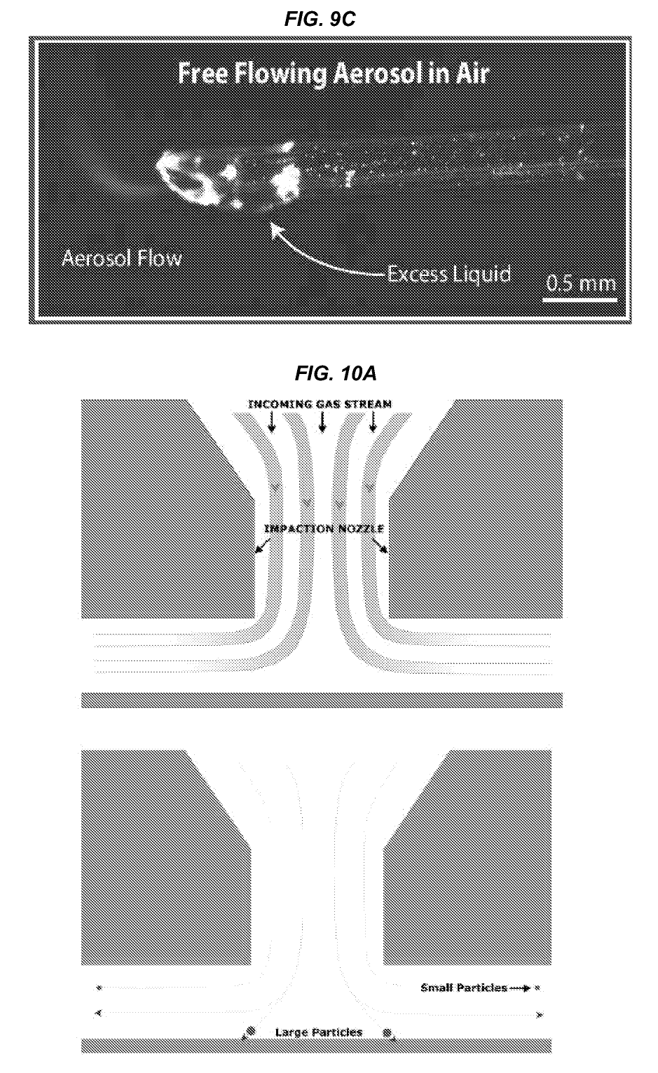

Aerosol drug delivery to a micro-scale device can cause accumulation in micro-diameter feed tube (e.g., capillary tubing such as glass tubing). For example, when a small volume of aerosol is sampled from an aerosol producing element (e.g., a commercial prescription nebulizer), aerosolized liquid droplets can coalesce on the walls of the feed tube (e.g., glass tubing) transporting droplets in air from the aerosol producing element (e.g., a commercial prescription nebulizer) to the microchannel (FIG. 9A). Large droplets on the wall of the feed tube (e.g., glass tubing) can grow from the droplet flow and occlude the air flow through the feed tube (e.g., glass tubing), clogging the flow of aerosol to the microchannel. Without wishing to be bound by theory, eventually, the clogging droplets can be rapidly forced out of the feed tube (e.g., glass tubing) towards the delicate cells (e.g., lung epithelial cells), potentially generating lethal shear forces at the air-liquid interface (FIG. 9B).

In one embodiment, surface treatment of the feed tube (e.g., glass tubing) can reduce contact angle and subsequent accumulation of liquid in the tubing. For example, in some embodiments, oxygen plasma treatment of the inner surface of the feed tube (e.g., glass tubing) can allow the droplets form a thin layer of liquid on the wall, thus allowing aerosol to flow more freely. In some embodiments, excess liquid can flow out of the end of the feed tube (e.g., glass tubing), forming a droplet on the outside of the tubing (FIG. 9C).

Aerosol Droplet Size Separation:

The upper airways of the lung can filter out larger droplets of aerosol before deposition on the alveolar epithelium. To mimic such aerosol droplet size separation, a miniature inertial impactor can be used in some embodiments of the aerosol delivery device/system to filter out larger droplets of aerosol before deposition on a microchannel. Without wishing to be bound by theory, larger droplets suspended in air have greater inertia than their smaller counterparts, resulting in a greater likelihood of hitting an obstacle in the flow path (FIG. 10A). Accordingly, for example, as shown in FIG. 10B, a miniature inertial impactor can be designed to have an aerosol inlet 132 (e.g., an outlet of the feed tube 130) extending into a chamber 150 in fluid communication with a microchannel 142, wherein the chamber 150 comprises an obstacle 152 (e.g., a chamber wall) placed at a pre-determined distance opposing to the aerosol inlet 132 (e.g., an outlet of the feed tube 130). While FIG. 10B shows that the feed tube 130 can deliver an aerosol from the side of a microfluidic device, in alternative embodiments, the feed tube 130 can deliver an aerosol from the top of a microfluidic device, e.g., as shown in FIG. 10C.

For illustrative purposes only and not to be construed to be limiting, aerosolized blue dye (e.g., 2.5 mM erioglaucine (Blue 1)) in isotonic saline can be introduced through the feed tube (e.g., glass tubing) of an inertial compactor described herein. Regardless of the placement position of the feed tube in a microfluidic device (e.g., a feed tube delivering an aerosol from the side, top and/or bottom of the microfluidic device), large droplets that can clog the microchannel preferentially deposited on the opposite wall 152 and were thus retained in the impactor (chamber 150); while small droplets preferentially followed air flow to the microchannel 142 and were thus deposited in the microchannel 142 (FIG. 10E).

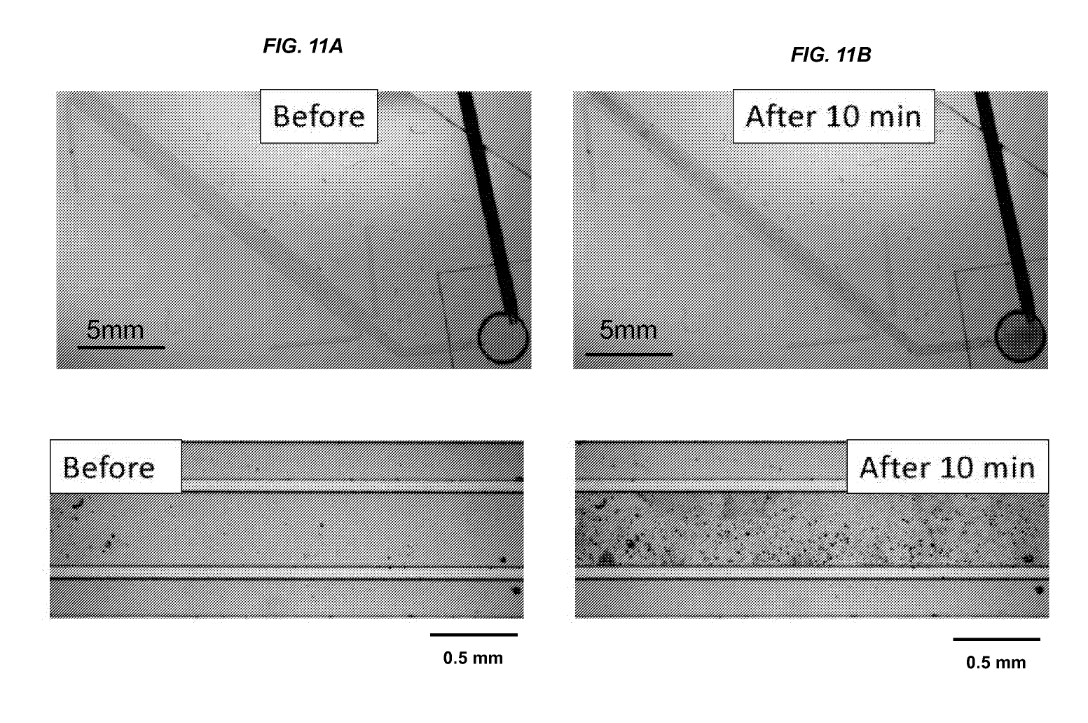

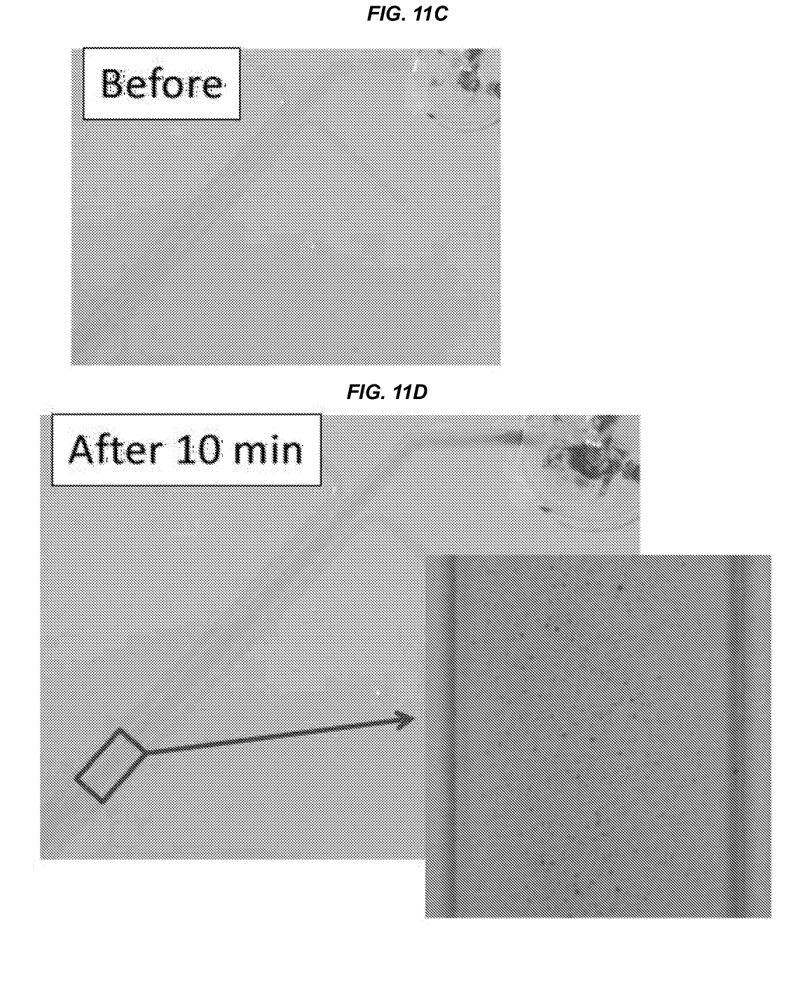

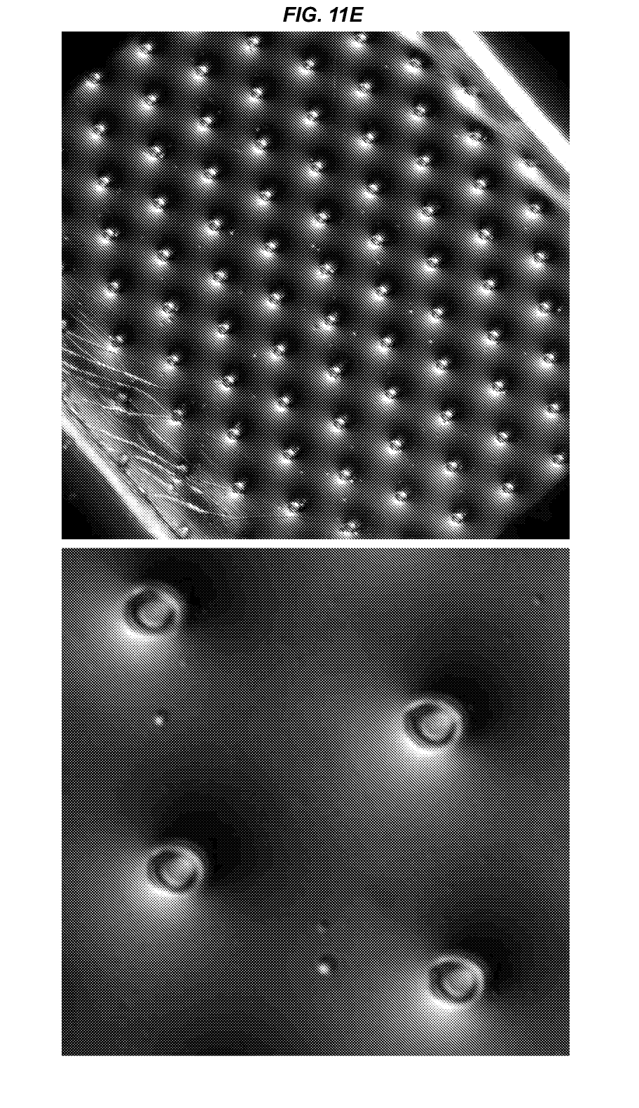

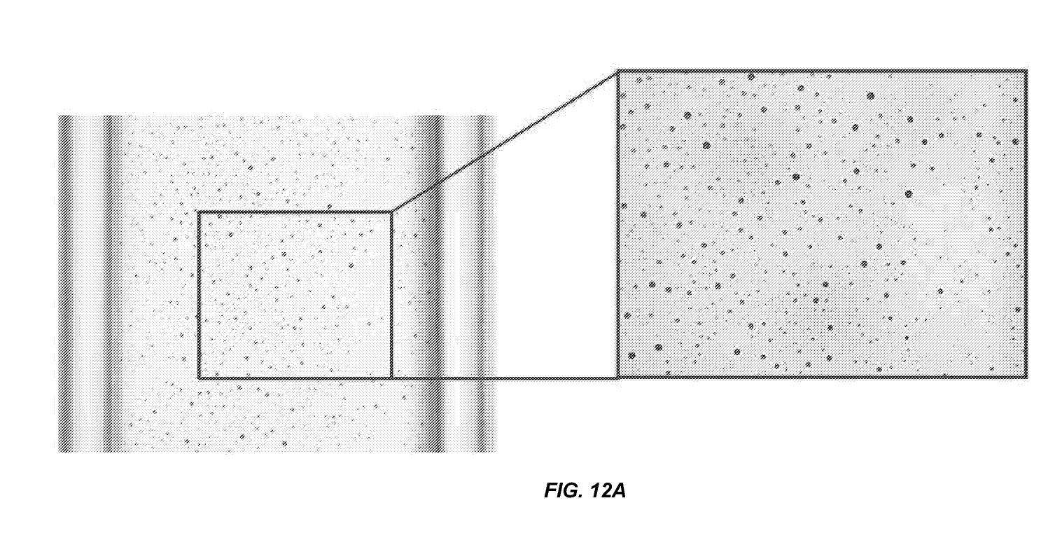

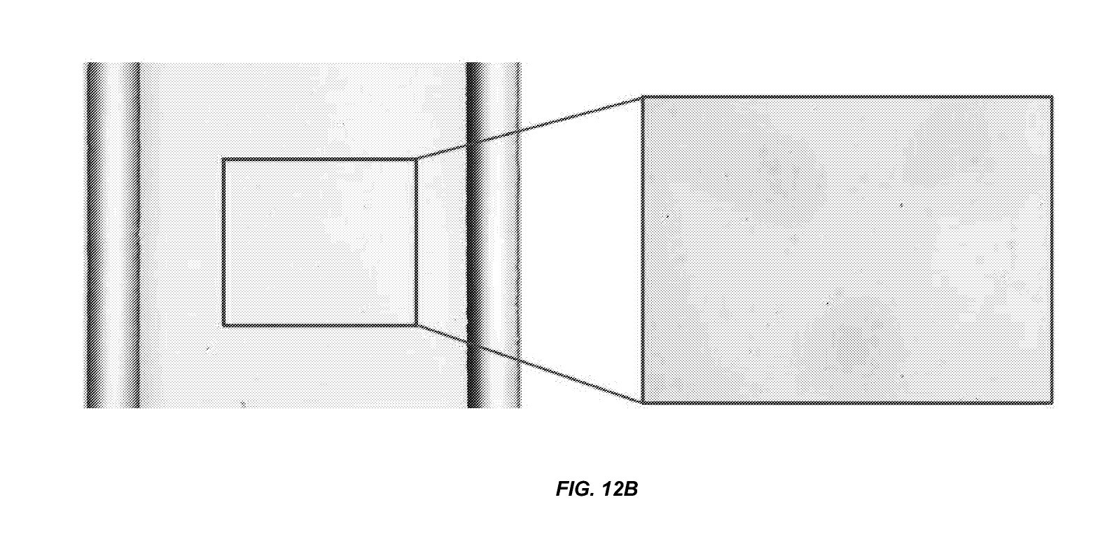

In some embodiments, the method and/or aerosol delivery device/system described herein can provide even aerosol deposition on at least a portion of a surface of a microfluidic channel, for example, as shown in FIGS. 11A-11E. In some embodiments, the method and/or aerosol delivery device/system described herein can provide a selective or localized aerosol deposition on at least a portion of a surface of a microfluidic channel. For example, as shown in FIGS. 12A-12B, there can be significantly more aerosol droplets deposited on the bottom surface of the microchannel than on the top surface of the microchannel.

Different geometries of a microfluidic channel can result in different aerosol deposition pattern and/or location within a microfluidic channel. In some embodiments, alternate geometries can lead to deposition of aerosol preferentially in the beginning of the microfluidic channel. For example, larger droplets can preferentially deposit at the beginning of the microfluidic channel. Slower flow rates can also result in preferential deposition of aerosol in the beginning of the channel.

### Example 3

### Aerosol Delivery of an Agent to Cells in a Microfluidic Device

In accordance with some embodiments described herein, an agent can be aerosolized and directed to a microfluidic channel for delivery of the agent to a cell. In some embodiments, the microfluidic channel can be present in a lung-on-a-chip device as described earlier. By way of example only, to evaluate efficacy of aerosol delivery to and/or deposition on a cell using one or more embodiments of the aerosol delivery device described herein, a monolayer of human alveolar epithelial cells (A549) was grown to confluence on the top side of a porous membrane of the lung-on-a-chip, for example, the one described in the International Patent Application WO 2010/009307, the content of which is incorporated herein by reference. In some embodiments, no cells were seeded on the bottom side of the membrane. By way of example only, as shown in FIG. 13, the top channel 1320 of the lung-on-a-chip 1300 was filled with air, and directly or indirectly connected to a feed tube 130 (e.g., with or without an inertial impactor) that delivers an aerosol from an aerosol producing element 110 (e.g., comprising a nebulizer 112); while the bottom channel 1330 could be optionally filled with media. In some embodiments, at least the top channel inlet port 1310 of the lung-on-a-chip 1300 can be modified to include an inertial impactor as described herein. For example, as shown in FIG. 13, the top channel inlet port 1310 can be modified for use as a chamber 150 of the inertial impactor. The microchannel 142 (in fluid communication with the chamber 150) and the porous membrane 160 can be directly or indirectly connected to the top channel 1320 and the porous membrane 1340 of the lung-on-a-chip 1300. For example, in some embodiments, the microchannel 142 (in fluid communication with the chamber 150) and the porous membrane 160 can be a direct extension of the top channel 1320 and the porous membrane 1340 of the lung-on-a-chip 1300. In some embodiments, the microchannel 142 (in fluid communication with the chamber 150) can be indirectly connected to the top channel 1320 of the lung-on-a-chip 1300, e.g., via an adapter such as another tubing or microchannel. In such embodiments, a porous membrane can be absent from an inertial impactor described herein.

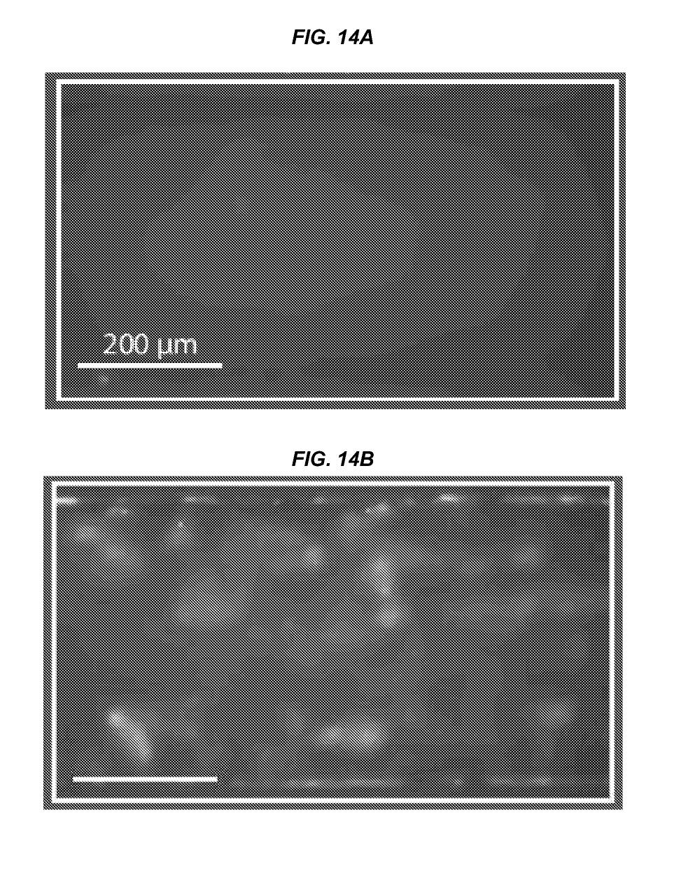

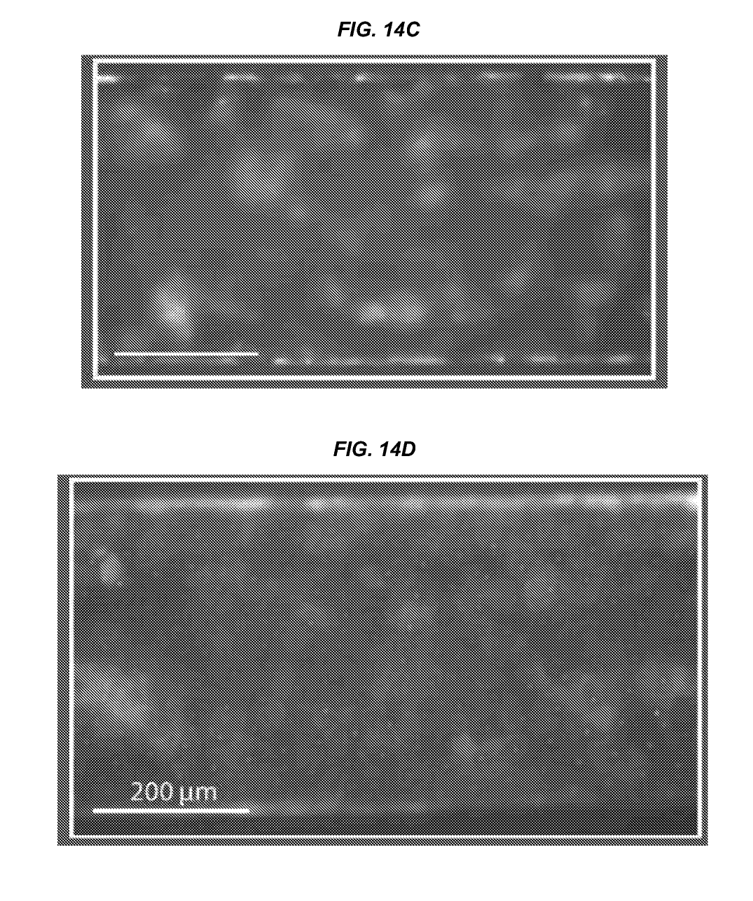

For illustrative purposes only and not to be construed to be limiting, the model agent for aerosol delivery can include a drug, a chemical, a nanoparticle, a biologics of interest or any agent described herein. In one embodiment, the model agent was 50 micromolar fluorescein sodium in isotonic PBS, which was nebulized into droplets of desirable micro sizes, e.g., about 0.1-10 microns or larger. In some embodiments, the aerosol droplets can have a size of about 1-5 microns. The aerosol droplets were introduced into the top microfluidic channel at a desirable flow rate, e.g., ˜20 mL/hr. In some embodiments, the aerosol droplet can be introduced into the top microfluidic channel at a flow rate lower or higher than about 20 mL/hr, depending on the dimensions of the microfluidic channels. FIGS. 14A-14D show that the aerosolized droplets of fluorescein deposited on the cells and were taken up by the cells after deposition.

Accordingly, some embodiments presented herein can be used for aerosol delivery to cells in a microfluidic device. The device/system and the method described herein can be used to deliver an aerosolized agent (e.g., but not limited to, a drug, a toxin and/or a nanoparticle) to any cells of interest in a microfluidic device that can mimic an organ function (e.g., but not limited to, lung epithelial cells at the air-liquid interface in a biomimetic lung device). In some embodiments, the agent can be present in any form, e.g., liquid or dry powder. In some embodiments, the device/system and method described herein can provide delivery of aerosolized dry powder to a biomimetic microfluidic device. Any dry powder aerosol drugs that are currently developed or art-recognized can be used in the method and/or system described herein. In some embodiments, the device/system and method described herein can be used to deliver an aerosolized drug formulation to one or more cells cultured in a microfluidic device (e.g., a lung-on-a-chip) for assessment of its toxicity on the cells. In some embodiments, the device/system and method described herein can be used to deliver aerosolized nanoparticles to one or more cells cultured in a microfluidic device (e.g., a lung-on-a-chip) for assessment of their toxicity on the cells. In one embodiment, the device/system and method described herein can be used to deliver an aerosolized agent (e.g., but not limited to, drugs, toxins, and/or nanoparticles) to one or more cells cultured in more than one microfluidic device, e.g., at least two microfluidic devices. For example, the device/system and method described herein can be used to deliver an aerosolized agent (e.g., but not limited to, drugs, toxins, and/or nanoparticles) to one or more cells cultured in a heart-lung micromachine, e.g., a heart-on-a-chip coupled with a lung-on-a-chip, for assessment of human pulmonary and/or cardiac toxicity of an aerosolized agent (e.g., aerosolized drug formulation if the agent include a drug) on the cells.

Other embodiments are within the scope and spirit of the invention.

Further, while the description above refers to the invention, the description may include more than one invention.

1.-61. (canceled)

62. A device comprising:
a microchannel; and
a droplet size separator comprising
a chamber,
an aerosol inlet for transferring an aerosol to the chamber, wherein the aerosol inlet defines an axis to an aerosol flow,
an outlet coupled to the microchannel for delivering small droplets of the aerosol to the microchannel, and
a capture surface within the chamber and located away from the aerosol inlet such that one or more large droplets of the aerosol deposit on the capture surface, while the small droplets of the aerosol flows into the outlet.

63. The device of claim 62, wherein the small droplets of the aerosol flows toward the outlet at an angle relative to the axis, and the angle is between about zero degrees and about 180 degrees, or between about 30 degrees and about 150 degrees.

64. The device of claim 62, wherein the capture surface forms an angle with the axis defined by the aerosol inlet, and the angle ranges from greater than zero degrees to less than 180 degrees, or the angle is about 90 degrees.

65. The device of claim 62, wherein the aerosol inlet is coupled to an aerosol producing element, a feed tube, a flow-splitting device, or any combinations thereof.

66. The device of claim 65, wherein the inner surface of the feed tube is modified to reduce the contact angle of the droplets on the inner surface of the feed tube.

67. The device of claim 66, wherein the surface modification is selected from the group consisting of plasma cleaning, oxidization, covalent bonding of polar or non-polar moieties, coating with a polar or non-polar compound, and any combinations thereof.

68. The device of claim 62, wherein the chamber further comprises an additional outlet for transferring a portion of the aerosol away from the chamber.

69. The device of claim 62, wherein the microchannel comprises at least one micro-pillar disposed therein.

70. The device of claim 62, wherein the microchannel is coupled to a biomimetic organ on a chip device, or forms part of a microchannel of a biomimetic organ on a chip device.

71. A method for delivering an aerosol to a microfluidic module, the method comprising:
moving an aerosol from an aerosol inlet into a chamber;
separating, via a capture surface within the chamber, large droplets of the aerosol from small droplets of the aerosol;
permitting movement of the small droplets away from the capture surface toward the microfluidic module;
receiving, within at least one microchannel within the microfluidic module, the small droplets from the chamber.

72. The method of claim 71, wherein the small droplets are moved toward the microfluidic module at an angle in a range from zero degrees to about 180 degrees relative to an axis along which the aerosol is moved generally from the aerosol inlet into the chamber.

73. The method of claim 71, wherein more droplets of the aerosol deposit on a bottom surface of the at least one microchannel than on a top surface of the microchannel.

74. The method of claim 71, wherein the microchannel comprises on its surface at least one cell, and at least a portion of the droplets deposit on the at least one cell.

75. The method of claim 71, wherein the aerosol comprises an agent.

76. The method of claim 75, wherein the agent comprises a therapeutic agent, a toxin, a cell, a bacterium, a virus, a particulate, a pollutant, a contaminant, a biologic, an infectious agent, or any combinations thereof.

77. The method of claim 71, further comprising detecting a response of the at least one cell after exposure to the agent for a period of time, thereby determining an effect of the aerosolized agent on the at least one cell.

78. A device for monitoring a biological function, comprising:
a body having a first microchannel, a second microchannel, and at least one aerosol input port leading into at least one of the first microchannel and the second microchannel;
a membrane located at an interface region between the first microchannel and the second microchannel, the membrane including a first side facing toward the first microchannel and a second side facing toward the second microchannel, the first side having cells of a first type adhered thereto; and
a droplet size separator comprising a chamber, an aerosol inlet for transferring an aerosol to the chamber, and a capture surface within the chamber, the capture surface being located away from the aerosol inlet such that one or more large droplets of the aerosol deposit on the capture surface, while small droplets of the aerosol flow into the at least one aerosol input port.

79. The device of claim 78, wherein the membrane is porous.

80. A method of introducing an aerosol to a device for monitoring a biological function, the device having a membrane located at an interface region between a first microchannel and a second microchannel, a first side of the membrane facing the first microchannel and having a first type of cells adhered thereto, a second side of the membrane facing the second microchannel, the method comprising:
moving an aerosol from an aerosol inlet into a chamber;
separating, via a capture surface within the chamber, large droplets of the aerosol from small droplets of the aerosol; and
introducing the small droplets into at least one of the first microchannel and the second microchannel.

81. The method of claim 80, further comprising moving a fluid through at least one of the first microchannel and the second microchannel.
